(19) United States
(12) Patent Application Publication
(10) Pub. No.: US 2026/0045091 A1
(43) Pub. Date: Feb. 12, 2026

(54) Human Subject Tracking in Secure Environment

(71) Applicant: Metropolis IP Holdings, LLC, Santa Monica, CA (US)

(72) Inventors: Xuan Guo, Belfast (GB); Yang Yuan, Belfast (GB); Dieter Joecker, Burgthann (DE)

(21) Appl. No.: 19/287,234

(22) Filed: Jul. 31, 2025

Related U.S. Application Data
(60) Provisional application No. 63/680,649, filed on Aug. 8, 2024.

(51) Int. Cl. G06V 20/52; G06V 20/40

(52) U.S. Cl. CPC G06V 20/52; G06V 20/41

(57) ABSTRACT

A system for multitask detection performs subject tracking by processing image frames from one or more video cameras deployed in a monitored environment. The system uses a neural network to detect human subjects in each frame and extracts feature sets for each subject. These features include a semantic center of the body and directional vectors extending to other body parts, such as the head or face, forming a subject-specific fingerprint. The system compares these fingerprints across frames to identify instances of the same subject over time. By correlating subject positions in image frames with the geolocation data of the capturing cameras, the system computes global coordinates for each subject. Using both the subject-specific fingerprints and spatial coordinates, the system determines trajectories of individuals, including transitions between camera views.

### TECHNICAL FIELD

The present disclosure relates generally to computer vision and machine learning, and more particularly to systems and methods for performing multitask detection and tracking of subjects in digital images and video streams.

### BACKGROUND

Traditional video surveillance and subject tracking systems typically rely on separate, task-specific detectors for identifying human features such as faces, heads, and bodies. These fragmented approaches introduce inefficiencies and inconsistencies, as each component must be executed independently and lacks shared context. As a result, grouping different body parts into coherent subject representations becomes error-prone-especially in crowded scenes or where parts of the body are occluded or out of frame.

Such traditional surveillance systems lack the capability to consistently track subjects across time and space, especially when individuals exit and re-enter the field of view or transition between cameras.

Furthermore, conventional pose estimation models assume full-body visibility and are highly sensitive to missing joints or partial occlusion. These systems fail to produce useful results in many common scenarios-such as detecting someone partially obscured by furniture or another person.

### SUMMARY

The present disclosure relates to a system and/or a method for tracking human subjects in secure environments using a neural network-based video analysis system. The system receives a series of image frames from one or more video cameras situated within a monitored area. For each image frame, a neural network detects one or more human subjects and extracts features for each detected individual. These features include a semantic center representing a stable anatomical point on the body, and a directional vector—such as to the head or face—that forms part of a subject-specific fingerprint.

The system compares these fingerprints across multiple frames to associate subject detections over time, even when captured by different cameras. To enable robust cross-camera tracking, the method transforms image-space positions into global coordinates using camera calibration data and determines subject trajectories based on both spatial and visual similarity. In some embodiments, the system applies zone-based transitions, motion modeling using Kalman filters, and temporal constraints to improve track continuity.

In some embodiments, a centralized interface may aggregate detections and threat alerts across distributed sites, with per-site threat levels computed based on event severity, frequency, and confidence. The disclosed embodiments provide enhanced accuracy and reliability for persistent identity tracking in complex, multi-camera surveillance environments.

### BRIEF DESCRIPTION OF THE DRAWINGS

FIG. 1 illustrates an example system environment for distributed tracking of human subjects across multiple video sources, in accordance with one or more embodiments.

FIG. 2 illustrates an example architecture of a subject tracking system, in accordance with one or more embodiments.

FIG. 3 illustrates an example architecture of a multitask detection module (which may correspond to the multitask detection module of FIG. 2), in accordance with one or more embodiments.

FIG. 4 illustrates an example output of a multitask detection module, in accordance with one or more embodiments.

FIG. 5A illustrates the subject in an extended pose, wherein the subject's right arm is stretched outward.

FIG. 5B illustrates the same subject in the same pose and within the same bounding box.

FIGS. 5C and 5D are schematic illustrations demonstrating an obstruction scenario and corresponding differences in bounding box prediction strategies applied to a partially occluded human subject within an image, in accordance with one or more embodiments.

FIG. 6 is a schematic diagram illustrating an exemplary decoding of a body bounding box for a detected human subject in an image based on predicted semantic center coordinates and associated boundary offsets, in accordance with one or more embodiments.

FIG. 7A depicts a first stage of the regression process for estimating intermediate anatomical keypoints, in accordance with one or more embodiments.

FIG. 7B illustrates the second stage of the two-stage regression process, in which final anatomical keypoints (also referred to as posture keypoints) are refined using the intermediate keypoints as anchor references, in accordance with one or more embodiments.

FIG. 7C illustrates an example of body part association using a vector for associating multiple detected anatomical components of a single human subject, in accordance with one or more embodiments.

FIG. 8A illustrates an example monitoring environment equipped with multiple cameras for performing human subject detection and tracking, in accordance with one or more embodiments.

FIGS. 8B and 8C illustrate an example scenario in which a human subject transitions between two spatially separated image capture zones monitored by cameras with non-overlapping fields of view, in accordance with one or more embodiments.

FIG. 9A illustrates an example image frame depicting a human subject and the associated detection outputs generated by a multitask detection module, in accordance with one or more embodiments.

FIG. 9B illustrates an example image frame depicting a human subject partially occluded and the associated detection outputs generated by a multitask detection module, in accordance with one or more embodiments.

FIG. 10 illustrates a training process for constructing a unified multitask detection model using a teacher-student knowledge distillation framework, in accordance with one or more embodiments.

FIG. 11 is a flowchart of a method for human subject tracking in secure environments, in accordance with one or more embodiments.

FIG. 12 is a block diagram of an example computer suitable for use in the networked computing environment of FIG. 1, in accordance with one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Conventional video surveillance and behavior detection systems suffer from several technical limitations that reduce their utility in real-world deployments. These systems often rely on separate, task-specific models for detecting distinct human body features such as faces, heads, and bodies. As a result, detections are fragmented, lack shared contextual representations, and are difficult to associate with a single human subject-particularly in crowded environments or where occlusion and partial visibility are present. Furthermore, traditional systems typically use geometric centers of bounding boxes for localization, which are unstable during dynamic movement, limb extension, or non-frontal poses, thereby undermining the consistency of tracking and behavior recognition.

Moreover, conventional tracking systems often fail to preserve subject identity across frames and across multiple cameras. These failures arise from dependence on low-dimensional appearance features or heuristic rules that are not robust to variations in lighting, camera angle, or occlusion. Existing systems also lack mechanisms to map detections to global spatial coordinates, which precludes consistent subject tracking across non-overlapping camera views.

Embodiments described herein addresses the foregoing limitations by providing systems and methods for multitask detection and tracking of human subjects using a unified model and a hierarchical tracking architecture.

In some embodiments, a single multitask neural network model receives an input image and concurrently predicts locations of multiple human body features, including the face, head, body, and posture keypoints, in a unified forward pass. The model leverages shared feature representations and branching task-specific prediction heads to ensure efficient and consistent detection across subtasks.

In some embodiments, the system determines a semantic center for each detected human subject, the semantic center comprising a stable anatomical point such as the mid-torso. This semantic center is used as a reference for subsequent bounding box prediction and keypoint estimation, thereby improving localization accuracy and robustness under partial occlusion or distorted poses.

In some embodiments, the system generates directional vectors—also referred to herein as “vectors”—from the semantic center to additional body parts such as the head or face. These vectors encode spatial relationships and serve as part of a subject-specific appearance fingerprint that remains invariant across frames and camera views.

In some embodiments, subject detections are further mapped from pixel coordinates to global coordinates using camera calibration data. This calibration enables conversion of local detections into real-world spatial positions, which may be used to determine whether two detections from different cameras correspond to the same individual.

In some embodiments, the system further extracts high-dimensional feature embeddings for body parts including the face, head, and torso, and uses these embeddings to determine similarity between detections. This enables appearance-based matching of human subjects across cameras, including cameras with non-overlapping fields of view.

In some embodiments, subject trajectories are constructed by integrating appearance fingerprints, semantic center tracking, and global location estimation over time. The resulting trajectories preserve subject identity across frames and across cameras, and support real-time alerts, behavior analytics, and retrospective search capabilities.

In some embodiments, the system enables adaptive identity association and re-identification across variable visibility conditions by leveraging independent and joint detections of face, head, and body regions over time. For example, when a subject enters the scene with their back turned to the camera, the system may initiate tracking based solely on head and body detections, even in the absence of facial visibility. As the subject moves through a crowded environment where their body becomes occluded, the tracking may continue using the head as a standalone anchor. Once the subject's face becomes visible, the system correlates the newly acquired facial detection with the historical head and body trajectory, retroactively linking the facial data to prior track segments. When all three modalities—face, head, and body—are concurrently visible, the system performs joint association across these features to reinforce tracking stability and reduce error. This multi-modal fusion architecture enables graceful fallback and recovery across partial occlusions and visibility changes, ensuring robust identity continuity even under fragmented or noisy observations.

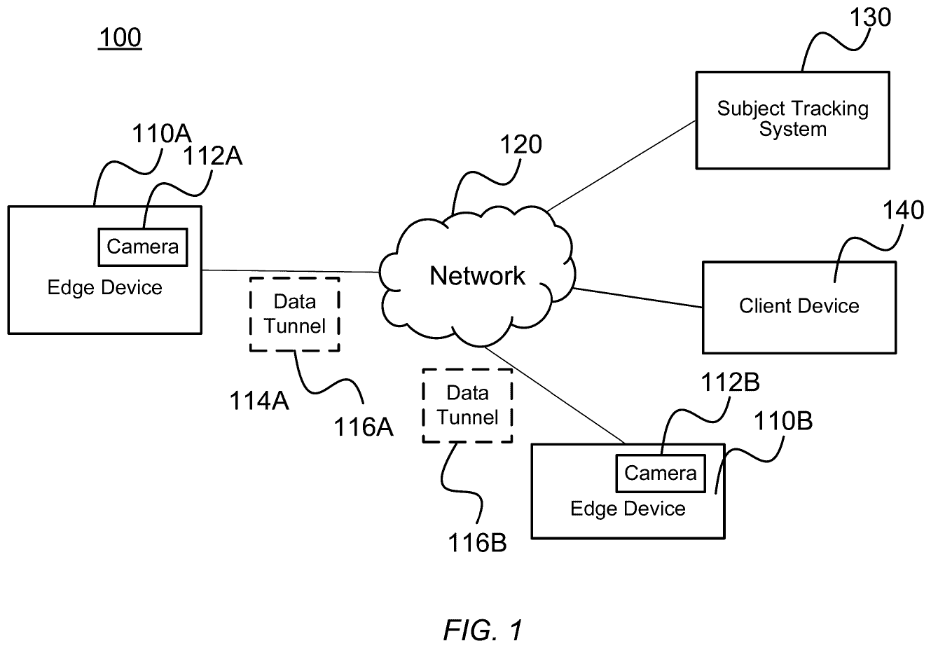

Additional details about the application and training of the multitask detection system are further described below with respect to FIGS. 1-11.

### Example System Environment

FIG. 1 illustrates an example system environment 100 for distributed tracking of human subjects across multiple video sources, in accordance with one or more embodiments. Environment 100 includes multiple edge devices 110A and 110B, each connected to corresponding cameras 112A and 112B, one or more data tunnels 116A and 116B, network 120, a subject tracking system 130, and a client device 140.

Edge devices 110A and 110B are localized computing platforms configured to interface with cameras 112A and 112B, respectively. Each edge device may receive video feeds from one or more associated cameras and process the data using on-device analytics. In some embodiments, edge devices 110A and 110B execute machine learning models configured to perform person detection, pose estimation, semantic center localization, and part-to-whole association. The edge devices may generate tracking data, posture data, or feature vectors, which are subsequently communicated to the subject tracking system 130 via network 120.

Data tunnels 116A and 116B represent secure, possibly encrypted, communication channels between edge devices and remote services. For example, edge device 110A may transmit video analysis results or subject metadata through data tunnel 116A to network 120, while edge device 110B may transmit similar data through data tunnel 116B. These tunnels enable privacy-aware transfer of information with minimized latency.

Network 120 may comprise a local area network (LAN), cellular network (e.g., 4G or 5G), or wide-area network (WAN), and facilitates bidirectional communication between the edge devices and external computing systems including the subject tracking system 130 and client device 140.

Client device 140 represents a computing device used by operators, administrators, or users of the system. In some embodiments, client device 140 may be used to configure detection parameters, receive real-time alerts, view reconstructed subject trajectories, or access historical logs. The client device may operate as a web or mobile application and may communicate with the subject tracking system 130 through network 120.

Subject tracking system 130 is a centralized or cloud-based system configured to aggregate and reconcile tracking information from multiple edge sources. In some embodiments, subject tracking system 130 maintains temporal identifiers, generates cross-camera subject handoffs, and constructs composite representations of individuals based on inputs received from the edge devices. The system may further apply person re-identification models, trajectory prediction, or behavior recognition based on accumulated multi-view data.

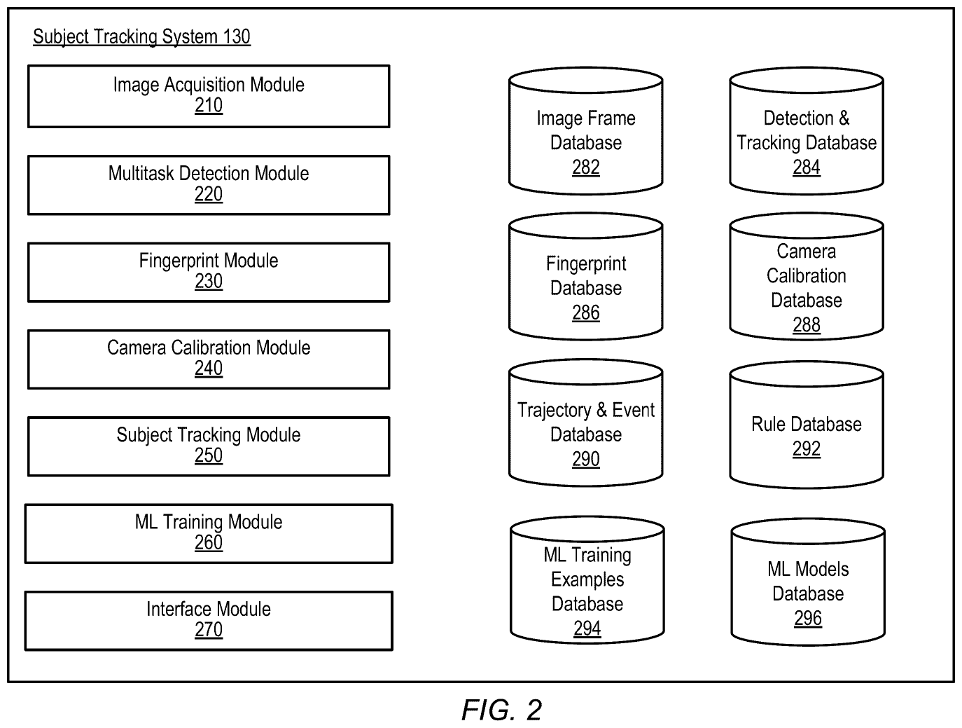

Additional details about the subject tracking system 130 are further described below with respect to FIGS. 2-11.

### Example Subject Tracking System

FIG. 2 illustrates an example architecture of a subject tracking system 130, in accordance with one or more embodiments. The subject tracking system 130 includes an image acquisition module 210, a multitask detection module 220, a fingerprint module 230, a camera calibration module 240, a subject tracking module 250, a machine-learning (ML) training module 260, and an interface module 270. The subject tracking system 130 also include multiple databases, such as an image frame database 282, a detection and tracking database 284, a fingerprint database 286, a camera calibration database 288, a trajectory and vent database 290, a rule database 292, an ML training examples database 294, and an ML models database 296. In some embodiments, there may be more or fewer modules as illustrated in FIG. 2. In some embodiments, functions of multiple modules may be combined into a single module, and functions of a single module may be divided into multiple modules.

The image acquisition module 210 is configured to receive a plurality of image frames from one or more video cameras positioned in a monitored environment. The image acquisition module 210 establishes communication with the video cameras using one or more standard streaming protocols, such as Real-Time Streaming Protocol (RTSP), Hypertext Transfer Protocol (HTTP), or camera-specific application programming interfaces (APIs). In some embodiments, the image acquisition module 210 may support both real-time streaming and access to pre-recorded video footage stored on local or network-attached storage devices.

In some embodiments, the image acquisition module 210 is configured to continuously receive or poll image frames from the video cameras at predetermined frame rates or time intervals. The image acquisition module 210 may further perform preprocessing operations on each acquired image frame. Such preprocessing may include associating the image frame with metadata such as a timestamp, a unique camera identifier, image resolution, and, where available, geolocation coordinates corresponding to the position of the capturing camera.

In some embodiments, the image acquisition module 210 may include one or more buffering mechanisms configured to address variability in network latency and ensure temporal synchronization of frames received from multiple video cameras. The image acquisition module 210 may further implement quality control processes, including but not limited to, validation of image frame integrity, detection of corrupted frames, and automatic re-requesting or retrying of frames in the event of acquisition failure. The image frames, along with their associated metadata, are stored temporarily or queued for processing by one or more downstream modules, such as the multitask detection module 220.

The multitask detection module 220 is configured to process each image frame to detect various human-related characteristics, including the head, face, body, and/or posture keypoints. In some embodiments, the multitask detection module 220 employs a shared feature extraction backbone, such as a convolutional neural network (CNN) or transformer-based model (e.g., ResNet, EfficientNet, or Vision Transformer), to generate multi-scale feature representations of each input image frame. The shared backbone encodes both low-level visual cues and high-level semantic information across the spatial dimensions of the image.

Following the shared backbone, the multitask detection module 220 includes a pre-trained multitask detection model having plurality of task-specific output modules, each configured to detect a particular human-related feature. In some embodiments, the multitask detection module 220 is configured to perform unified human subject detection by executing multiple interrelated tasks within a single model architecture. In some embodiments, the multitask detection module 220 includes multiple models configured to perform different tasks.

In some embodiments, the multitask detection module 220 generates a detection heatmap identifying semantic centers for predefined body portions such as the face, head, and body. The multitask detection module 220 may further refine these initial detections by applying stricter validation criteria to reduce false positives. Based on the identified semantic centers, the multitask detection module 220 predicts bounding box dimensions for each detected body portion using offset values, and applies sub-pixel adjustments to correct spatial misalignments introduced by feature map downsampling. In some embodiments, the multitask detection module 220 may predict anatomical posture keypoints, including skeletal joints, relative to each subject's semantic center, and computes visibility confidence scores for these keypoints to account for occlusions or limited field of view. The module may also generate directional vectors linking detected body parts, enabling grouping of related features into unified subject representations. In some embodiments, the multitask detection module 220 further includes a decoding process that aggregates and interprets the outputs from all internal tasks—such as detection, shape prediction, posture keypoint estimation, visibility scoring, and part association—and produces a final subject-level output comprising bounding boxes, anatomical keypoints, visibility flags, and grouped body part associations for each detected human subject.

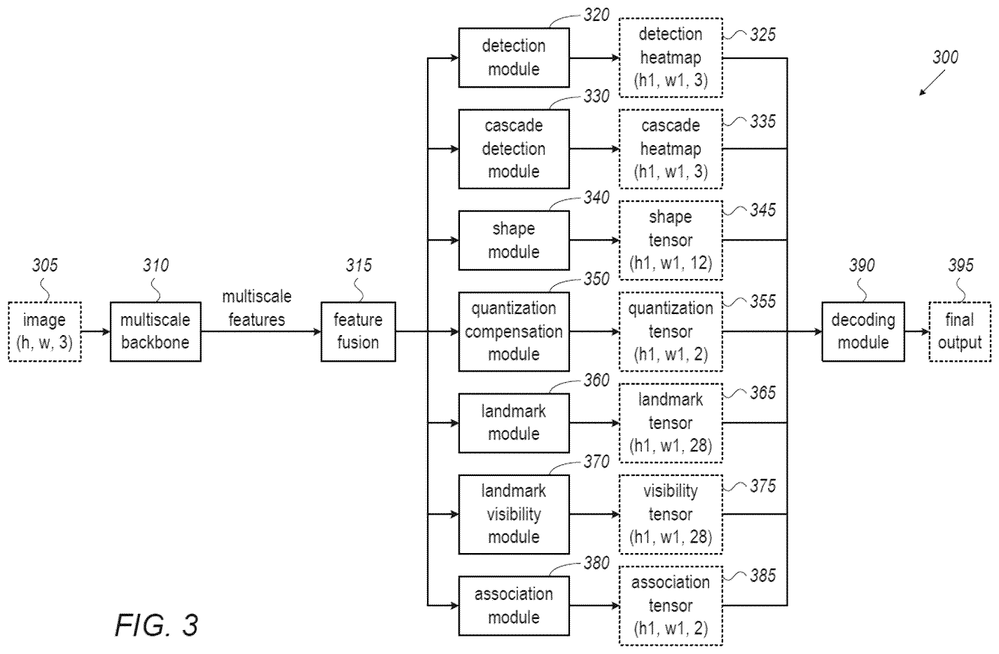

The use of a unified architecture of a multitask detection model enables efficient inference by sharing the computational cost of feature extraction across all detection tasks. Meanwhile, the task-specific output heads allow for independent optimization of each detection function, improving detection accuracy and robustness. Additional details about the multitask detection model are further described below with respect to FIG. 3.

The fingerprint module 230 is configured to generate feature embeddings or “fingerprints” for each detected subject using visual characteristics extracted from face, head, and body regions. In some embodiments, the fingerprint module 230 receives detection results from the multitask detection module 220, including bounding boxes corresponding to detected facial regions, heads, body, and full-body outlines, as well as pose keypoints associated with anatomical landmarks.

For each detected subject, the fingerprint module 230 may extract cropped image regions based on the bounding boxes and performs preprocessing operations to normalize the visual input. Such preprocessing may include pixel normalization, histogram equalization, geometric alignment, or rotation correction to produce standardized inputs for subsequent feature extraction. In some embodiments, the preprocessing may further align cropped regions based on keypoint geometry to improve consistency across pose variations.

In some embodiments, the fingerprint module 230 may include one or more deep neural networks trained to extract discriminative feature embeddings from the preprocessed regions. These networks may include facial recognition architectures such as FaceNet or other custom-trained convolutional neural networks configured to capture body-level or head-level appearance features. The fingerprint module 230 may generate high-dimensional embedding vectors, which may include 128 to 512 floating point values, that represent each subject's visual fingerprint.

In some embodiments, the fingerprint module 230 further determines a semantic center of the subject's body by analyzing the distribution of pose keypoints. The semantic center may correspond to an anatomically stable region such as the mid-torso. The module calculates directional vectors from the semantic center to other key body parts, including the head and face. These vectors serve as structural features that complement the appearance-based embeddings and provide a geometric fingerprint that remains stable across pose changes and varying viewpoints.

To improve robustness, the fingerprint module 230 may be configured to generate embeddings that are invariant to changes in lighting, minor occlusions, and moderate differences in subject orientation. In some embodiments, the feature extraction network is trained using metric learning techniques such as triplet loss or contrastive loss, allowing embeddings of the same individual to cluster tightly in feature space while maintaining separation from embeddings of other individuals.

The resulting appearance and geometric fingerprints are stored in the fingerprint database 286 along with metadata such as timestamp, subject ID, and associated camera information. These fingerprints may then be used by the subject tracking module 250 and other components of the subject tracking system 130 to perform identity matching, re-identification across frames, and cross-camera subject association.

The camera calibration module 240 is configured to transform image-space coordinates into global spatial coordinates by applying intrinsic and extrinsic camera calibration parameters. The camera calibration module 240 may perform extrinsic calibration to establish the position and orientation (pose) of the camera relative to a global coordinate frame. The extrinsic parameters are represented by a rotation matrix and a translation vector, which define the transformation from the camera's local coordinate system to the world coordinate system. In some embodiments, the camera's mounting height is measured and factored into the calibration model to support ground-plane-based subject localization.

The camera calibration module 240 may further compute the effective field of view of each camera based on focal length and sensor dimensions, thereby defining the spatial coverage region of the camera. In some embodiments, the camera calibration module 240 may also compensate for lens distortions, including radial and tangential distortion, which can lead to inaccuracies in spatial localization-especially near the image periphery. Correction algorithms may be applied to undistort captured frames before coordinate transformation.

In some embodiments, the camera calibration module 240 is configured to transform detected subject coordinates from image-space (pixel coordinates x, y) into world-space coordinates (X, Y, Z) using homography matrices or projective geometry techniques. For human tracking applications constrained to a ground plane, the camera calibration module 240 may assume a fixed height (Z) and derive the X and Y coordinates via inverse perspective mapping or plane homography transformations.

Calibration parameters for each camera may be stored in the camera calibration database 288. The camera calibration module 240 may also implement automated recalibration workflows to compensate for physical camera displacement, environmental drift, or hardware replacement. In some embodiments, the camera calibration module 240 is configured to compute a reprojection error metric or other calibration quality indicators to assess the validity of the current calibration and may trigger recalibration when error thresholds are exceeded.

The calibrated global coordinates produced by the camera calibration module 240 are used by the subject tracking module 250 and other components to perform multi-camera identity association, global trajectory estimation, and accurate spatial reasoning across the monitored environment.

In some embodiments, the camera calibration module 240 supports semantic partitioning of the monitored environment into spatial zones, wherein each zone is associated with a distinct region of interest (ROI), functional role, or access rule. A zone may be defined using real-world coordinates derived from the camera calibration module, and may be represented as a polygonal boundary or grid cell within a global floor plan. In some embodiments, the global position and orientation of the camera may be determined based on geospatial sensors coupled to the camera, such as GPS receivers and digital compasses, to establish the camera's geographic coordinates and viewing direction. Alternatively, these values may be manually determined and entered into the camera calibration module 240. These values serve as absolute reference points for mapping observed subject positions into global coordinates.

Zone identifiers may be assigned to spatial coordinates calculated from subject detections, enabling per-frame assignment of each subject to one or more zones. The zone assignment process may be performed by evaluating whether the global position of a subject's semantic center falls within the geometric boundary of a predefined zone.

According to some aspects, the system may classify zones by type (e.g., corridor, entryway, waiting area), and may apply rule-based or machine-learned logic to infer behaviors specific to those zones. For example, loitering may be defined by a subject remaining within a waiting area zone for more than a threshold time, while intrusion may be triggered by unauthorized entry into a restricted zone.

The zone metadata may be stored in association with trajectory records in the trajectory and event database, enabling downstream modules to perform temporal zone analysis, rule-based alerting, and semantic behavior interpretation. Zone definitions may also be used for camera view overlap resolution, disambiguating subject paths near boundaries between camera views.

The subject tracking module 250 is configured to maintain persistent subject identities over time by associating detections across sequential frames and camera views. In some embodiments, the subject tracking module 250 may implement a multi-stage tracking pipeline that integrates motion modeling, appearance-based matching, and spatial correlation using global coordinate data.

In some embodiments, the subject tracking module 250 utilizes multi-hypothesis tracking frameworks to account for uncertainty in subject motion and detection reliability. Motion prediction may be performed using Kalman filters or Extended Kalman Filters, which estimate future subject positions based on prior state variables, including position, velocity, and acceleration, while incorporating noise models to account for uncertainty in both motion and measurement.

In some embodiments, tracking process begins by associating current frame detections—such as bounding boxes and fingerprint embeddings—with existing subject tracks. In some embodiments, the subject tracking module 250 employs data association algorithms including the Hungarian algorithm or Joint Probabilistic Data Association (JPDA) to resolve multiple candidate matches. Association cost functions may be computed using a weighted combination of spatial distance (e.g., based on global coordinates from the camera calibration module 240), appearance similarity (e.g., based on fingerprint vectors from the fingerprint module 230), and predicted motion alignment from the motion model.

When the appearance embeddings and spatial proximity of a newly detected subject fall within predefined thresholds relative to an existing track, the subject tracking module 250 updates the track and confirms continuity of identity. The subject tracking module 250 May further account for motion directionality, time elapsed since last observation, and confidence scores associated with each detection to improve robustness against noise and occlusion.

In multi-camera deployments, the subject tracking module 250 may further perform inter-camera association and identity handoff. Subjects detected near the edge of one camera's field of view may be projected into a shared coordinate system and matched against detections from an adjacent camera using a combination of global position, time alignment, and fingerprint similarity. In some embodiments, each camera sends its detection results—including global coordinates and fingerprint embeddings—to the subject tracking system 130, which maintains a global view of all cameras. Alternatively, each camera transmits its video feed to the subject tracking system 130, which then performs subject detection and fingerprinting on the received frames. In response to determining that a subject is approaching the boundary of one camera's view, the system 130 predicts a likely reappearance region in adjacent camera views based on the subject's motion trajectory and timestamp. The system 130 may then query detection data from those adjacent cameras for matching fingerprint embeddings and spatial-temporal consistency. In response to finding a match, the system 130 continues tracking the subject's trajectory in the new camera's coordinate space, preserving subject identity across the transition. This enables tracking of subjects as they transition between non-overlapping or partially overlapping camera views.

In some embodiments, the subject tracking module 250 is configured to handle temporary occlusions or dropouts by maintaining track hypotheses during periods in which the subject is not visible. If the subject reappears within a reasonable spatial and temporal window, the track is reactivated and continued. Track management logic may include (but is not limited to) track initiation (when a new subject is first detected), track maintenance (updating an existing track with new detections), and track termination (when the subject has exited the monitored area or has remained undetected for a specified duration).

The output of the subject tracking module 250 may include subject identifiers, trajectory coordinates, time intervals, and track status, which may be stored in the detection and tracking database 284 and used for real-time alerting, forensic review, or behavioral analysis.

In some embodiments, the subject tracking module 250 distinguishes between intra-camera tracking and inter-camera tracking. Intra-camera tracking maintains subject identity across sequential frames captured by the same camera, even under conditions of occlusion, pose variation, or partial visibility. Inter-camera tracking associates detections of the same subject across multiple cameras, including those with non-overlapping fields of view, by using a combination of spatial position, feature embedding similarity, and calibrated global coordinates.

In some embodiments, for subject tracking purposes, the subject tracking module 250 applies relaxed similarity thresholds compared to those used in facial recognition watchlist applications. Whereas watchlist identification requires high precision and strict matching, the tracking system operates under the assumption that resolving a small number of candidate matches (e.g., among 2-50 nearby subjects) is sufficient. Accordingly, embeddings are compared with lower threshold values to allow for continuity of identity even under minor appearance changes or environmental variation.

In some embodiments, the subject tracking module 250 may implement a graph-based tracking framework in which individual subject detections across frames and cameras are represented as nodes in a directed acyclic graph (DAG). Each node corresponds to a detected subject instance in a particular image frame, characterized by a semantic center, timestamp, camera identifier, and associated fingerprint vector. Directed edges are established between temporally adjacent nodes if the subject embeddings and spatial features meet predefined similarity criteria.

Edge costs may be computed as a weighted function of spatial distance in world coordinates, visual similarity between fingerprint embeddings (e.g., cosine or Euclidean distance), and motion model consistency (e.g., Kalman filter prediction overlap). A path-finding algorithm such as Viterbi decoding, Dijkstra's algorithm, or greedy hypothesis propagation may be applied to identify the most likely sequence of detections corresponding to a single individual over time. This graph structure enables robust identity association across occlusions, abrupt motion changes, and transitions between non-overlapping cameras, providing a flexible framework for managing multiple hypotheses and enabling retrospective correction of erroneous matches via graph pruning or reweighting.

In some embodiments, the subject tracking module 250 computes a probabilistic association score for each candidate detection pair by evaluating a combination of appearance similarity, spatial transition likelihood, and temporal consistency. The appearance similarity may be determined by calculating a similarity metric, such as cosine distance, between fingerprint vectors extracted from respective detections. The spatial transition likelihood considers whether the subject's trajectory plausibly connects an exit zone associated with the first detection and an entry zone associated with the second detection, based on the known physical layout of the environment. Temporal consistency is evaluated by comparing the elapsed time between the two detections to an expected travel time range derived from inter-zone distances and typical subject speeds. The resulting association score reflects the overall likelihood that two detections observed in separate camera views, including those with non-overlapping fields of view, correspond to the same individual.

The subject tracking module 250 continuously monitors detection and association confidence scores for each tracked subject. When confidence scores fall below a configurable threshold—due to visual occlusion, poor lighting, or motion blur—the subject tracking module 250 may temporarily suspend updates to the corresponding subject identity to prevent propagation of erroneous states. During this suspension period, the system may retain the subject's last known state and maintains the track as dormant for a predefined time window.

In some embodiments, the subject tracking module 250 employs predictive models, such as Kalman filters or recurrent motion estimators, to extrapolate the expected location of the subject during the dormant period. If new detections become available that match the predicted location within an error bound and satisfy re-identification criteria (e.g., fingerprint similarity, spatial proximity, or velocity continuity), the dormant track is reactivated and merged with the new observation. This enables backtracking and recovery of broken trajectories resulting from transient detection failures.

Furthermore, the subject tracking module 250 may tag tracks affected by suspected failure modes for downstream review or analysis. These tags can be stored in the trajectory and event database 290 and used to trigger alerts or model retraining events. By incorporating adaptive failure recovery mechanisms, the system maintains robust and reliable subject tracking performance across a range of operational scenarios, including partially observed scenes, crowded environments, and degraded input quality.

In some embodiments, the subject tracking module 250 is further configured to perform dynamic, modality-adaptive subject association using independent and joint detections of face, head, and body features across time. The system initiates tracking based on whichever anatomical features are initially visible-such as head and body when the face is not visible due to back-facing orientation. As visibility conditions change (e.g., body occlusion in a crowd), the system may maintain the track using the head as a standalone identifier. When the subject's face becomes visible at a later point, the tracking module correlates the face with historical head and body detections using geometric vectors and appearance embeddings, thereby retroactively linking facial identity to the full trajectory. This enables re-identification and identity consolidation over time. When multiple modalities (face, head, and body) are detected concurrently, the tracking module fuses the corresponding data to increase tracking confidence and mitigate ambiguity. This flexible architecture enables graceful fallback and recovery in the presence of occlusion, pose change, and environmental noise, enhancing long-term tracking continuity and identity persistence.

The machine-learning (ML) training module 260 supports the training and refinement of the system's underlying machine learning models, including detection, fingerprinting, and tracking components. In some embodiments, the ML training module 260 receives labeled training data from the ML training examples database 294. The training data may include annotated image frames, bounding boxes, pose keypoints, semantic centers, and identity labels. The module applies a variety of data augmentation techniques to increase model generalization, including image rotation, scaling, flipping, color jittering, and geometric transformations.

For the multitask detection model, the ML training module 260 may implement joint training procedures in which multiple task-specific loss functions (e.g., for face detection, body detection, and pose estimation) are combined using weighted summation. In some embodiments, the ML training module 260 applies knowledge distillation by using one or more high-capacity teacher models to supervise the training of a smaller student model optimized for deployment on edge devices. The student model learns to replicate the behavior of the teacher model using softened labels or intermediate feature representations generated by applying the teacher models to unlabeled datasets.

In some embodiments, the ML training module 260 may also perform transfer learning by initializing a model with weights pre-trained on a large-scale dataset and fine-tuning it on domain-specific data from the intended deployment environment. This enables the model to adapt to specific lighting conditions, camera angles, and scene characteristics present in the target use case.

In some embodiments, the ML training module 260 includes evaluation and validation components that assess model performance on held-out validation datasets. The module may implement early stopping criteria based on validation loss or accuracy to prevent overfitting. Hyperparameter optimization routines may be applied to tune learning rates, batch sizes, weight decay coefficients, and other training parameters for improved performance.

In some embodiments, the ML training module 260 maintains detailed training records including training logs, loss curves, and evaluation metrics. Models produced by the training module are versioned and stored in the ML models database 296. Versioning enables reproducibility, rollback, and systematic comparison of different training iterations. The output models are deployed to the appropriate modules within the subject tracking system 130 for inference.

The ML training module 260 may be retrained or fine-tuned periodically during system operation, enabling the model to self-improve based on real environmental situations. In some embodiments, the retraining process may be triggered based on performance degradation metrics (e.g., declining detection accuracy or increased false association rate), or scheduled during low-usage periods. Updated models are versioned and validated against a reserved test set before deployment. The trained machine learning models may be deployed on the edge devices 110 or integrated into the subject tracking system 130 for inference and analysis in real time or near real time. Edge devices 110 may receive incremental updates in the form of model deltas to minimize transmission overhead.

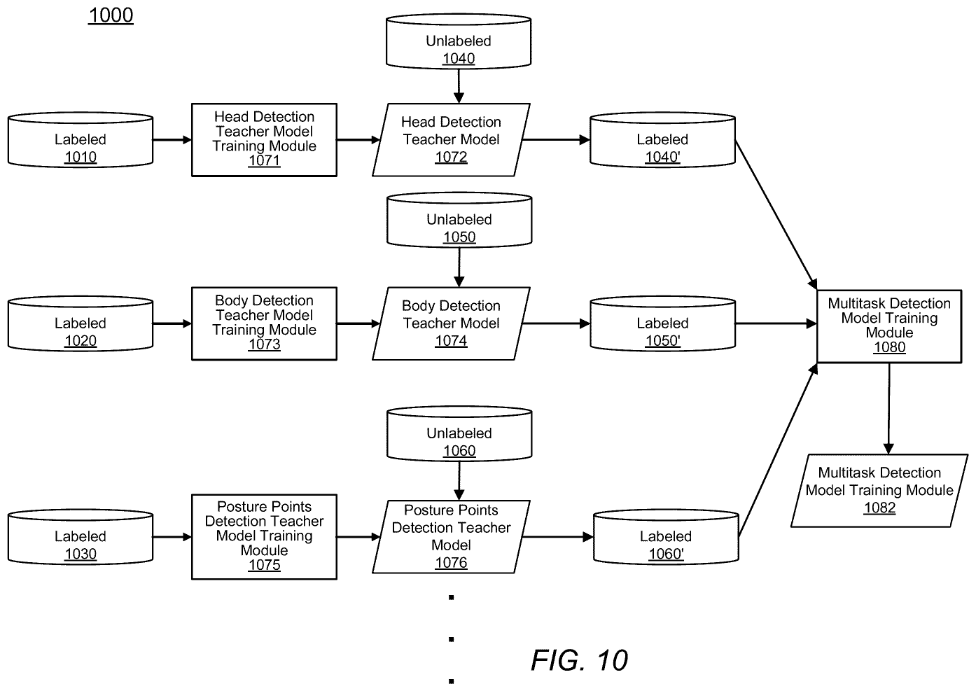

This incremental learning architecture ensures that the deployed subject tracking system continuously improves over time, adapts to site-specific characteristics, and maintains detection robustness in changing environments without requiring centralized retraining from scratch. Additional details about ML training module 260 are further described below with respect to FIG. 10.

The interface module 270 provides a user interface for configuration, control, and visualization. Users may define detection and tracking rules, monitor alerts, review subject activity, and visualize live or historical data. The interface module 270 may be operable in a client-server architecture in which a backend component provides access to system data and control functions via application programming interfaces (APIs), and a frontend component renders interactive visualizations and dashboards for user interaction.

In some embodiments, the interface module 270 includes a configuration interface that enables users to define detection and tracking parameters, establish connections to video cameras, configure region-of-interest (ROI) settings, and specify alert rules. Users may also adjust system sensitivity thresholds, set event durations for triggering alerts, and apply camera-specific configurations to tailor detection behaviors.

The interface module 270 provides real-time monitoring capabilities through live camera feed visualization with graphical overlays indicating detected subjects, subject identifiers, tracking trajectories, and alert statuses. In some embodiments, the module establishes persistent communication channels using WebSockets, Server-Sent Events (SSE), or similar protocols to deliver low-latency updates of detection results and system diagnostics.

The interface module 270 may also enable users to interact with tracking data through selectable overlays and subject-specific visualizations. A user may, for example, select a subject from a live view or list to view that subject's complete movement trajectory, examine associated metadata, or review detection confidence levels. Historical views allow examination of prior movements over time, including path reconstruction and replay functionality.

In some embodiments, the interface module 270 includes interactive visualization components such as environment maps showing subject positions and movement paths, timeline views for reviewing activity over specified intervals, and dashboard panels displaying aggregate statistics. These may include subject counts, alert frequency, occupancy heatmaps, and behavioral trend summaries.

In some embodiments, the interface module 270 may support advanced querying capabilities, enabling users to search for specific subjects by identifier or biometric signature, filter activity by time range or camera, and generate reports summarizing tracking data. The interface module 270 may further include alert management tools allowing users to review, acknowledge, or annotate alerts, configure delivery mechanisms (e.g., email, SMS, or messaging platform), and manage alert history logs.

In some embodiments, the interface module 270 may display system diagnostics, including camera connection status, processing latency, frame ingestion rates, and database health indicators. These diagnostics enable system administrators to monitor the operational status of the subject tracking system 130 and respond to performance or hardware issues in real time.

In some embodiments, the interface module 270 may include a centralized monitoring interface that aggregates alerts from multiple geographically distributed sites into a unified dashboard. Each site is represented as a tile or node within a map-based or grid-based user interface. The system may compute a confidence-weighted threat level for each site based on the volume, severity, and type of events detected by the tracking system. The interface enables rapid triage by security personnel and may prioritize sites requiring immediate attention. Alerts may be aggregated from real-time or historical data, and interactive drill-down is supported for site-specific review.

The image frame database 282 may store raw or preprocessed image frames along with associated metadata. The image frame database 282 serves as a high-throughput repository for both raw and preprocessed image frames, supporting real-time operations, retrospective forensic analysis, and offline machine learning workflows.

The detection and tracking database 284 stores outputs generated by the multitask detection module and subject tracking module. The detection and tracking database 284 serves as the central data repository for bounding box information, pose keypoints, subject identifiers, and movement trajectories. In some embodiments, the detection and tracking database 284 stores detection results in a normalized format, including bounding box coordinates (e.g., x, y, width, height) for detected faces, heads, and full-body regions. Each detection record may further include a confidence score indicating the reliability of the prediction. Pose estimation data is stored as coordinate arrays representing anatomical landmarks such as joint or limb positions, accompanied by visibility flags that indicate whether each keypoint is visible, occluded, or uncertain.

The fingerprint database 286 maintains appearance embeddings computed by the fingerprint module 230. Each record includes a subject identifier, embedding vector, camera ID, and/or timestamp. In some embodiments, the fingerprint database 286 may be a high-performance biometric repository that enables efficient identity matching under varying environmental and observational conditions.

In some embodiments, each record stored in the fingerprint database 286 includes a high-dimensional embedding vector comprising, for example, between 128 and 512 floating-point values. The embedding vector encodes distinctive visual characteristics derived from facial features, body appearance, head geometry, or combinations thereof.

Each fingerprint record may further include a subject identifier, which may be system-generated or, in some embodiments, linked to known identities through external identity management systems. In some embodiments, the fingerprint database 286 also stores camera identifiers indicating the source of the biometric data, thereby enabling multi-camera association and cross-referencing of identity across sensors.

In some embodiments, fingerprint entries are timestamped (e.g., with millisecond-level precision) to allow for temporal analysis. In some embodiments, the timestamp information is used to analyze appearance variation over time due to factors such as changes in clothing, lighting conditions, or subject orientation. The fingerprint database 286 may retain multiple fingerprint instances for the same subject collected at different times or from different cameras to improve matching reliability.

The camera calibration database 288 stores per-camera calibration parameters used by the camera calibration module. The camera calibration database 288 serves as a persistent repository for both intrinsic and extrinsic calibration parameters associated with each video camera in the monitored environment.

In some embodiments, the camera calibration database 288 stores intrinsic camera parameters including focal length values (fx, fy), principal point coordinates (cx, cy), and lens distortion coefficients. The distortion model may include radial distortion terms (k1, k2, k3) and tangential distortion terms (p1, p2), which are derived from calibration procedures such as checkerboard or planar target-based imaging using methods like Zhang's algorithm or bundle adjustment optimization.

In some embodiments, the camera calibration database 288 further stores extrinsic camera parameters including rotation matrices and translation vectors, which define the orientation and spatial position of each camera relative to a global coordinate reference frame. These parameters enable transformation of detected subject locations from camera coordinate systems into shared world coordinates, thereby supporting multi-camera subject tracking and spatial reasoning.

In addition to geometric calibration data, the camera calibration database 288 may include physical mounting specifications such as the vertical mounting height of each camera relative to the ground plane, tilt and pan angles, and zoom levels for pan-tilt-zoom (PTZ) cameras. Field of view (FOV) parameters may also be maintained, including horizontal and vertical angular coverage and depth of field characteristics, which define each camera's spatial coverage area.

In some embodiments, the camera calibration database 288 maintains transformation matrices used to convert between coordinate spaces, such as pixel coordinates to normalized camera coordinates, camera coordinates to world coordinates, and inter-camera coordinate transformations. These matrices enable accurate position estimation, subject trajectory construction, and camera handoff operations across the tracking system.

The trajectory and event database 290 contains computed subject movement trajectories and higher-level behavior or event records. The trajectory and event database 290 functions as the analytical core of the system, supporting both real-time situational awareness and retrospective forensic investigations.

In some embodiments, the trajectory and event database 290 stores subject trajectories as time-series data comprising sequences of global spatial coordinates. Each trajectory may further include associated kinematic data, such as velocity vectors, acceleration values, and changes in direction. Additional metadata fields may include trajectory confidence scores, smoothing coefficients, and interpolation flags indicating regions where tracking continuity was interrupted and subsequently estimated.

The trajectory and event database 290 may further store behavioral event records derived from analysis of subject movement patterns. In some embodiments, zone entry and exit events are generated when a subject crosses a defined geofence or geographic boundary. Such events may include zone identifiers, timestamps for entry and exit, and calculated dwell durations. The database may also include loitering events, which are detected based on prolonged stationary behavior within a predefined area and time threshold.

In some embodiments, the trajectory and event database 290 records unauthorized access events triggered when a subject enters a restricted area or appears during a predefined prohibited time window. These events may include subject identifiers, location data, timestamps, and the nature of the rule violation.

In some embodiments, the trajectory and event database 290 maintains relational links between event records and their originating trajectory data, enabling full reconstruction of behavioral sequences and contextual conditions surrounding any detected event. This integrated structure supports in-depth forensic analysis, allowing authorized users to trace the timeline, movement path, and contributing factors associated with a specific alert or behavioral outcome.

The rule database 292 stores user-defined conditions for triggering alerts or modifying system behavior. The rule database 292 supports a flexible rule engine architecture that enables users to configure and deploy customizable monitoring policies tailored to specific operational environments, temporal constraints, and spatial contexts.

In some embodiments, the rule database 292 stores rule definitions as structured logic expressions that specify trigger conditions, logical operators, and corresponding actions. Time-based rules may define activation parameters such as specific hours of the day, days of the week, or calendar date ranges during which particular monitoring behaviors or alert conditions are active or inactive.

The rule database 292 may further support region-of-interest (ROI) rules that define geographic boundaries, such as virtual zones within the field of view of a camera or mapped areas within the global coordinate system. These rules may specify triggering conditions based on subject activity within the defined regions, such as entry, exit, dwell duration, or movement direction. Each rule may be linked to one or more monitored zones and include parameters such as allowable dwell time or maximum occupancy.

In some embodiments, identity recognition rules may be configured to monitor specific subjects of interest by associating known fingerprint vectors or biometric identifiers with alert actions. These rules enable targeted surveillance and real-time notification when a designated subject is detected within the monitored environment.

In some embodiments, the rule database 292 also supports behavioral threshold rules that define quantitative parameters such as minimum loitering time, maximum walking speed, maximum group size, or activity duration. If these thresholds are exceeded by one or more tracked subjects, the system 130 may generate an alert or initiate a corresponding automated response.

In some embodiments, the rule database 292 enables complex logical conditions through the use of Boolean operators such as AND, OR, and NOT. This allows users to define multi-condition rules, such as triggering an alert only if a subject enters a restricted zone and exceeds a speed threshold during certain hours. The rule logic may be extended through nested conditions or priority-based evaluation sequences.

In some embodiments, the rule database 292 supports real-time rule enforcement by continuously evaluating detection, tracking, and behavioral data produced by other modules of the subject tracking system 130. When one or more rule conditions are satisfied, the system 130 may perform predefined actions, such as generating an alert, dispatching a notification, logging an event, or initiating a control signal to an external system.

In some embodiments, the rule database 292 further includes rule management functionality, including rule prioritization, conflict resolution mechanisms for handling overlapping or contradictory rules, and temporary rule deactivation for testing or maintenance. The rule database 292 may support rule templates and inheritance structures that facilitate the rapid deployment of rule sets across multiple cameras, zones, or monitoring scenarios.

The ML training examples database 294 stores curated examples used for training or fine-tuning machine learning models. The ML training examples database 294 supports supervised learning, knowledge distillation, and model validation workflows by providing structured and versioned access to labeled datasets.

In some embodiments, the ML training examples database 294 stores image data annotated with ground truth labels, including bounding box coordinates for detected human features such as faces, heads, body, and/or full body. Each image may also include associated classification labels, quality scores, and contextual metadata. Annotated pose keypoints may be stored as coordinate arrays with accompanying visibility flags, landmark identifiers, and confidence scores derived from manual annotation or automated labeling tools.

In some embodiments, the ML training examples database 294 further stores semantic center annotations, which serve as ground truth for training the body center detection. These annotations include (x, y) coordinate values representing stable anatomical centers, as well as associated confidence metrics. Such data enables accurate learning of center estimation models that are invariant to pose and occlusion.

In some embodiments, the ML training examples database 294 supports knowledge distillation processes by storing outputs from one or more teacher models alongside human-annotated ground truth labels. This configuration enables training of student models that leverage both manual annotations and the predictive distributions of high-capacity teacher networks.

The ML models database 296 maintains trained versions of machine learning models deployed within the system. The ML models database 296 may support model lifecycle management, including version control, performance tracking, and deployment orchestration for all neural network components and supporting algorithms within the system.

The ML models database 296 may also store the multitask detection model, fingerprinting models, including embedding dimensionality, similarity threshold parameters, and internal feature extraction configurations. Temporal tracking models stored in the ML models database 296 may include both traditional algorithmic configurations, such as Kalman filter parameters, and neural network-based motion prediction models trained to forecast subject trajectories.

The ML models database 296 includes a model versioning system that records each training cycle and tracks model evolution over time. This allows for comparison of different model versions, facilitates reproducibility, and supports rollback to prior model states in cases where newer versions exhibit degraded performance. Version identifiers, creation timestamps, and model lineage metadata are maintained for each stored model.

### Example Multitask Detection Module

FIG. 3 illustrates an example architecture of a multitask detection module 300 (which may correspond to the multitask detection module 220 of FIG. 2), in accordance with one or more embodiments. The multitask detection module 300 includes a multiscale backbone module 310, a feature fusion module 315, a detection module 320, a cascade detection module 330, a shape module 340, a quantization compensation module 350, a landmark module 360, a landmark visibility module 370, an association module 380, and a decoding module 390. In some embodiments, there may be more or future modules implemented as illustrated in FIG. 3. In some embodiments, functions of multiple modules may be combined into a single module, and functions of a single module may be divided into multiple modules.

The multiscale backbone module 310 is configured to receive an input image 305 and extract feature representations at multiple spatial resolutions. The multiscale backbone module 310 receives, as input, an image 305 having dimensions (h, w, 3), corresponding to the height, width, and three color channels (e.g., RGB) of the image. The multiscale backbone module 310 applies a series of convolutional operations to extract hierarchical feature representations across multiple spatial scales.

In some embodiments, the multiscale backbone module 310 may be implemented using a deep convolutional neural network architecture, such as ResNet, MobileNet, EfficientNet, or a comparable neural network backbone. The network may be pretrained on large-scale image datasets to improve generalization to diverse visual conditions. In some embodiments, the convolutional layers of the backbone may be organized into a plurality of stages, wherein each stage progressively reduces the spatial resolution of the feature maps while increasing their channel depth and semantic abstraction. The multiscale backbone module 310 outputs a plurality of feature maps at different spatial resolutions. These feature maps, representing various levels of spatial and semantic granularity, are transmitted to a feature fusion module 315.

The feature fusion module 315 is configured to integrate the multiscale feature maps generated by the backbone module 310 into a unified shared feature map. Each of the feature maps received by the feature fusion module 315 may be associated with a different spatial resolution and level of semantic abstraction, corresponding to outputs from various stages of the multiscale backbone. In some embodiments, the feature fusion module 315 is configured to preserve both fine-grained spatial detail and high-level semantic information for multitask detection. To achieve this, the feature fusion module 315 may employ one or more fusion strategies, including, but not limited to, channel-wise concatenation of feature maps, weighted averaging based on learned fusion weights, or attention-based mechanisms that selectively enhance feature components relevant to downstream tasks. In some embodiments, the fusion module 315 may implement principles of a Feature Pyramid Network (FPN), bidirectional feature fusion networks, or other hierarchical feature integration architectures that facilitate top-down and bottom-up information flow.

In some embodiments, the fusion operation addresses the trade-off between spatial resolution and semantic richness by aligning feature maps of differing resolutions. This alignment may be performed by upsampling lower-resolution feature maps to match higher-resolution dimensions, downsampling higher-resolution maps to integrate semantic context, or combining both approaches depending on task requirements. The resulting fused feature map preserves the localization precision of high-resolution inputs while benefiting from the contextual robustness of deeper, lower-resolution features.

The output of the feature fusion module 315 is a shared fused feature map that is transmitted to a plurality of downstream modules, including but not limited to a detection module 320, cascade detection module 330, shape module 340, quantization compensation module 350, landmark module 360, landmark visibility module 370, and/or association module 380. By producing a single unified representation, the feature fusion module 315 enables efficient multitask inference without requiring redundant feature extraction for each subtask. This shared representation supports consistent interpretation and performance across detection, pose estimation, visibility analysis, and part association operations.

The detection module 320 is configured to generate a detection heatmap 325 from the shared fused feature map. The predefined body portions may include, for example, a face, a head, and a body. The detection module 320 receives, as input, a shared fused feature map generated by the feature fusion module 315 and applies a series of convolutional operations to produce a spatial probability distribution indicative of the presence of the respective body portions across the image.

In some embodiments, the detection module 320 generates a detection heatmap 325 having dimensions (h₁, w₁, 3), where h₁ and w₁ represent the height and width of the downsampled feature map, and the third dimension corresponds to separate prediction channels for face, head, and body detection, respectively. Each value within the detection heatmap 325 represents a confidence score indicating the likelihood that the respective spatial location corresponds to a semantic center of one of the predefined body portions.

The term “semantic center” refers to an anatomically stable reference point for a body portion, such as the torso center in the case of the body. This reference point provides consistent localization across varied human poses and is robust to partial occlusion. The semantic center may differ from the geometric center of a bounding box, particularly in scenarios involving non-standard poses or when body parts such as arms or legs extend beyond the torso region.

The detection module 320 may employ learned convolutional filters that have been trained to detect characteristic visual patterns associated with each body portion type. These filters evaluate localized features across the shared feature map and output classification confidence values for each spatial location. In some embodiments, the detection module 320 may further implement post-processing operations such as non-maximum suppression to eliminate redundant detections and retain only the most confident predictions for each body portion.

In some embodiments, the outputs of the detection module 320, including the detection heatmap 325 and the identified semantic centers, are forwarded to one or more downstream modules, such as a shape module 340, a landmark module 360, and an association module 380, to support further localization, keypoint detection, and grouping tasks. The use of semantic centers provides improved reliability and stability in multitask detection pipelines, enhancing detection accuracy in complex visual environments.

The cascade detection module 330 operates in conjunction with the detection module 320 to refine its predictions. The cascade detection module 330 operates as a secondary validation mechanism that applies more stringent detection criteria to reduce false positives and improve semantic center localization. The cascade detection module 330 receives, as input, the shared fused feature map generated by the feature fusion module 315 and processes this input using a separately trained detection sub-network.

In some embodiments, the cascade detection module 330 generates a cascade detection heatmap 335 having the same spatial dimensions as the detection heatmap 325 produced by the detection module 320. Each spatial location within the cascade detection heatmap 335 includes confidence values corresponding to predefined body portions, such as the face, head, or body. The cascade detection heatmap 335 is configured to reflect stricter detection thresholds, thereby validating and filtering preliminary detections.

In some embodiments, the cascade detection module 330 may participate in a two-stage filtering process, wherein each candidate semantic center identified in the detection heatmap 325 must also satisfy a secondary confidence condition derived from the cascade detection heatmap 335. In some embodiments, a location is retained as a valid detection only if both detection_heatmap[i, j] exceeds a detection confidence threshold and cascade_heatmap[i, j] exceeds a cascade confidence threshold. Locations that do not satisfy both conditions are excluded from further processing.

In some embodiments, by implementing a learned verification stage, the cascade detection module 330 applies additional contextual reasoning to disambiguate between true positives and visually similar false detections. This hierarchical filtering mechanism improves the precision of the multitask detection module 300 while preserving high recall performance. In some embodiments, the refined detection outputs are subsequently utilized by downstream modules, such as the shape module 340 and association module 380, to support robust bounding box generation, part association, and subject tracking.

The shape module 340 is configured to predict the geometric dimensions of bounding boxes for detected body parts based on the assumption that each pixel corresponds to a semantic center. The shape module 340 receives, as input, the shared fused feature map produced by the feature fusion module 315 and generates predictions representing the spatial extent of rectangular bounding boxes for detected body portions, such as the face, head, and body.

In some embodiments, the shape module 340 outputs a shape tensor 345 having dimensions (h₁, w₁, 12), wherein h₁ and w₁ correspond to the height and width of the downsampled feature map, and the twelve output channels represent bounding box parameters for three predefined body parts. Each body part—such as face, head, and body—is associated with four offset parameters representing the distances from the predicted semantic center to the top, bottom, left, and right edges of the bounding box.

The shape module 340 operates under the assumption that each spatial location in the feature map corresponds to a semantic center identified by the detection module 320. Based on this assumption, the shape module 340 predicts offset values relative to each semantic center, enabling the reconstruction of bounding boxes in the original image coordinate space. The use of offset-based regression, as opposed to direct coordinate prediction, allows for improved localization stability, particularly in scenarios involving non-standard poses or partial occlusion.

The bounding box prediction approach employed by the shape module 340 is robust to anatomical variation and pose distortion. For instance, when subjects extend limbs beyond their normal bounds, such as outstretched arms, the shape module 340 learns to extend bounding box boundaries accordingly to include the complete structure of the respective body part. The predicted offset values are later combined with the semantic center coordinates and adjusted using quantization compensation techniques, where applicable, to generate final bounding box coordinates aligned to the original input image resolution.

The output of the shape module 340, comprising the shape tensor 345, is provided to a decoding module 390 for further processing and integration. The bounding box information generated by the shape module facilitates accurate spatial localization of human subjects and is further used by downstream modules for posture estimation, subject association, and behavioral tracking.

The quantization compensation module 350 is configured to correct for spatial quantization errors introduced during image downsampling. As part of the feature extraction pipeline, the original input image is downsampled by a scale factor s to generate feature maps of reduced spatial resolution. This downsampling introduces discretization artifacts that may cause misalignment between predicted feature map coordinates and their corresponding positions in the original image space.

The quantization compensation module 350 receives, as input, the shared fused feature map generated by the feature fusion module 315 and preliminary bounding box predictions from the shape module 340. The module is configured to output a quantization tensor 355 having dimensions (h₁, w₁, 2), wherein each spatial location of the tensor includes a pair of sub-pixel offset values (i_quant, j_quant). These values represent fine-grained corrections to the pixel coordinates predicted by upstream modules.

In some embodiments, the quantization compensation module 350 learns to predict these correction values by analyzing local spatial gradients and feature patterns in the fused feature map. The module models the relationship between feature map coordinates and true object boundaries in the original image space, thereby mitigating spatial misalignment caused by discrete sampling. These predicted offset values are applied as additive corrections during bounding box reconstruction and semantic center localization.

In some embodiments, the final bounding box coordinates are computed using the corrected formula:

$$[ i \times s + i\_quant - left , j \times s + j\_quant - top , s + i\_quant + right , j \times s + j\_quant + bottom ] ,$$

where (i, j) represent the feature map coordinates, s is the scale factor between the input image and the feature map, and left, right, top, and bottom are the offset values predicted by the shape module 340.

The quantization compensation module 350 improves spatial accuracy in bounding box localization and semantic center determination. This enhancement is beneficial in applications requiring high-precision positioning, such as cross-camera subject tracking, pose estimation, or behavioral analysis in dense or occluded environments.

The landmark module 360 is configured to predict the positions of anatomical posture body points, such as skeletal joints, for each detected human subject. The landmark module 360 receives, as input, a shared fused feature map generated by the feature fusion module 315, and outputs a landmark tensor 365 having dimensions (h₁, w₁, 28), wherein each of the fourteen anatomical keypoints is represented by a pair of coordinate offsets (x, y) relative to a semantic center of a human body.

Each spatial location of the landmark tensor 365 is processed under the assumption that it corresponds to a semantic center of a human body, such as the torso center, and for each such location, the module predicts the relative positions of all fourteen anatomical landmarks. The predicted keypoints may include, for example, heads, shoulders, elbows, hips, knees, and ankles.

In some embodiments, the landmark module 360 implements a two-stage regression architecture to enhance anatomical precision. In a first stage, a convolutional sub-network, such as a three-layer convolutional neural network (CNN), predicts a set of intermediate anatomical landmarks, including shoulder midpoints and hip centers. These intermediate keypoints serve as stable references that are robust to pose variations and occlusion. In a second stage, a separate CNN with a smaller receptive field, such as a five-layer convolutional network, refines the prediction of posture body points by analyzing localized image features centered on the intermediate keypoints.

The hierarchical architecture enables the landmark module 360 to integrate both global body configuration and fine-grained visual cues, thereby improving pose estimation accuracy in complex environments, including crowded or partially occluded scenes. The module may apply bilinear interpolation techniques to extract high-resolution feature vectors at sub-pixel locations, enhancing localization precision.

The final predicted landmark positions are expressed as offsets from the corresponding semantic center, which improves generalization across subjects of different sizes and body configurations. These offsets can be transformed into absolute image coordinates by combining the semantic center location with predicted relative offsets and, optionally, quantization corrections. The output of the landmark module 360 may be used in downstream modules for subject tracking, behavior analysis, and motion interpretation.

The landmark visibility module 370 produces a visibility tensor 375 of shape (h₁, w₁, 28), representing visibility confidence scores (e.g., probabilities) for each of the 14 predicted posture points. The landmark visibility module 370 receives the same shared fused feature map as the landmark module 360 and generates a visibility tensor 375 having dimensions (h₁, w₁, 28). Each of the 28 channels corresponds to a visibility classification for one of the 14 posture body points, with each keypoint represented by a pair of probability values indicating visible versus non-visible states. In some embodiments, a sigmoid activation function is applied to normalize raw logits into visibility confidence scores ranging from 0 to 1.

The visibility prediction is performed under the assumption that each spatial location in the fused feature map corresponds to the semantic center of a human subject. For each such location, the module evaluates local and contextual visual cues to determine whether sufficient information is present for reliable keypoint detection. The module is trained to recognize common occlusion scenarios, such as body part overlap, obstruction by environmental objects, or truncation at image boundaries.

In some embodiments, the visibility module 370 incorporates spatial reasoning and depth-aware features to enhance occlusion detection, allowing it to differentiate between keypoints that are genuinely absent and those that are merely hidden from view. This enables the system to suppress unreliable keypoint predictions and to weight visible keypoints more heavily in downstream processing tasks.

The output of the landmark visibility module 370 is used in conjunction with the outputs of the landmark module 360 to inform downstream components such as tracking, pose smoothing, and behavior recognition. By providing visibility information, the module enables tracking systems to intelligently compensate for temporarily occluded keypoints using motion models or prior frame data, thereby improving the overall robustness and continuity of human pose estimation under real-world conditions.

The association module 380 is configured to group detected body parts belonging to the same individual. The association module 380 resolves spatial relationships between detected body portions, including faces, heads, bodies, and anatomical keypoints, and groups them under common subject identities in a single image frame, particularly in environments involving multiple individual.

The association module 380 receives, as input, the shared fused feature map generated by the feature fusion module 315. In some embodiments, the association module 380 also receives detection results from the detection module 320, shape module 340, landmark module 360, and other components. Based on the received information, the association module 380 generates an association tensor 385 having dimensions (h₁, w₁, 2), where each spatial element of the tensor comprises a predicted displacement vector—also referred to as a vector—representing the expected spatial offset from one predefined body portion to another.

In some embodiments, the association module 380 is configured to predict relative displacement vectors such as: (i) head-to-body vectors indicating the offset from the semantic center of a head to the semantic center of the corresponding body; (ii) face-to-head vectors indicating the offset between the detected face and the associated head center; and (iii) joint-to-body-center vectors for linking skeletal keypoints to the subject's overall representation. These vector predictions are learned from training data and encode both empirical observations and anthropometric priors relating to human body proportions.

In some embodiments, the association module 380 implements a multi-stage matching strategy to establish associations between detected body parts. In a first stage, candidate matches are evaluated based on detection confidence values derived from detection and heatmap scores. In a second stage, the association module 380 applies geometric plausibility constraints, including expected distance ratios, angular relationships, and alignment with human anatomical structure. In a third stage, the association module 380 optionally leverages temporal consistency by referring to previously associated identities in preceding image frames to promote stability across time.

The association module 380 may further implement ambiguity resolution strategies for handling partially occluded or visually ambiguous detections. In such scenarios, the association module 380 selectively uses visible body components to infer the likely location and identity of missing parts based on spatial alignment and historical appearance. In some embodiments, the association module 380 applies an optimization algorithm, such as the Hungarian algorithm, to solve the assignment problem when multiple potential matches exist for a single detected part. The final output of the association module 380 may include structured groupings of related detections, each attributed to a subject representation.

The decoding module 390 is configured to aggregate and interpret the outputs of all preceding modules, including tensors 325-385, and generate a final output 395. The decoding module 390 serves as a comprehensive integration engine that transforms intermediate model outputs into final subject-level detections suitable for downstream applications.

The decoding module 390 receives, as input, a plurality of prediction tensors, including but not limited to: a detection heatmap 325 generated by a detection module 320; a cascade heatmap 335 generated by the cascade detection module 330; a shape tensor 345 generated by a shape module 340; a quantization tensor 355 generated by the quantization compensation module 350; a landmark tensor 365 generated by a landmark module 360; a visibility tensor 375 generated by a landmark visibility module 370; and an association tensor 385 generated by an association module 380. These inputs collectively represent semantic centers, bounding box offsets, anatomical keypoints, keypoint visibility states, and spatial linkage vectors between detected body parts.

The decoding module 390 may be configured to apply a multi-stage reasoning process that performs conflict resolution, validation, grouping, and transformation of the received predictions. In some embodiments, the decoding module 390 first applies non-maximum suppression (NMS) algorithms to remove redundant or overlapping detections, followed by confidence-based filtering to discard predictions falling below a specified confidence threshold. Thereafter, the decoding module 390 may execute geometric consistency checks to ensure that grouped predictions exhibit plausible spatial relationships.

In some embodiments, the decoding module 390 uses the predicted association vectors (vectors) to group related body parts under a single subject identifier. This includes correlating facial, head, and body semantic centers with bounding boxes; aligning pose keypoints with visibility indicators; and resolving ambiguities through hierarchical matching and spatial proximity rules. The decoding process integrates these components into unified subject instances.

The final output 395 produced by the decoding module 390 may include (but is not limited to) one or more subject-specific data structures, each representing a distinct human subject in the image. Each subject-level output may include (but is not limited to): (i) coordinates of semantic centers (optionally refined using quantization offsets); (ii) bounding boxes for detected faces, heads, and bodies along with associated confidence scores; (iii) 14 posture body points with corresponding (x, y) coordinates; (iv) visibility flags for each keypoint; (v) appearance embeddings, if available; and/or (vi) temporal identifiers enabling continuity across sequential frames.

In some embodiments, the decoding module 390 may transform all coordinate predictions from the internal feature map space back to the original image coordinate system, accounting for downsampling factors and quantization corrections. This ensures that the final outputs are directly usable for real-time tracking, behavioral analysis, surveillance, and visualization systems. The structured output format facilitates interoperability with external systems and enables efficient processing pipelines for comprehensive human subject monitoring.

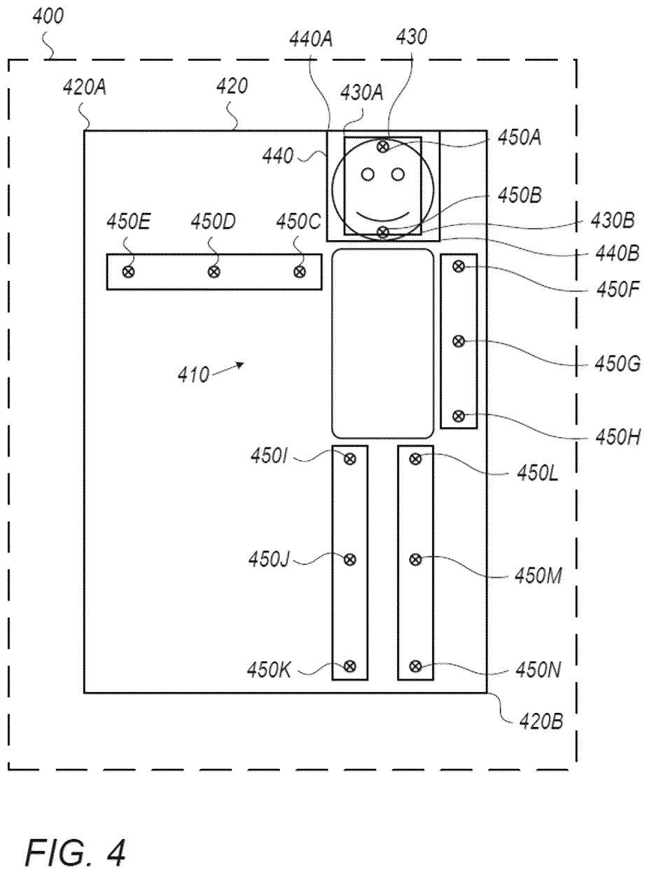

FIG. 4 illustrates an example output 400 of a multitask detection module 300, in accordance with one or more embodiments. The output 400 (which may correspond to final output 395 of FIG. 3) includes an image containing a human subject 410. The output includes predicted bounding boxes and anatomical keypoints that define the human subject's spatial configuration.

In particular, the output 400 includes an image with a body bounding box 420 defined by a top-left corner 420A and a bottom-right corner 420B. Within the body bounding box 420 is a head bounding box 440 defined by a top-left corner 440A and a bottom-right corner 440B. A face bounding box 430 is further shown within the head bounding box 440, and is defined by a top-left corner 430A and a bottom-right corner 430B.

The human subject 410 includes a plurality of posture body points 450A-450N, which correspond to anatomical landmarks detected by the multitask model. The keypoints may represent joints or skeletal features such as shoulders, elbows, hips, knees, and ankles. Each of these posture points may be associated with a visibility score as described with respect to the landmark visibility module 370.

In some embodiments, posture point 450A corresponds to top of the face, and posture point 450B corresponds to the bottom of the face of the subject. Posture points 450C and 450F may represent the left and right shoulders, while posture points 450D and 450G correspond to the left and right elbows, respectively. Posture points 450E and 450H correspond to the left and right wrists. Posture points 4501 and 450L denote the left and right hips, 450J and 450M correspond to the left and right knees, and 450K and 450N correspond to the left and right ankles.

The posture points 450A-450N may be generated by the landmark module 360, and each is positioned relative to a semantic center derived from the subject's body. These keypoints, together with the bounding boxes 420, 430, and 440, represent a complete spatial and semantic interpretation of the human subject 410. The associations between these body parts may be established by the association module 380 to form a coherent, subject-specific output. The final output may be used for downstream applications including tracking, behavior analysis, and activity recognition.

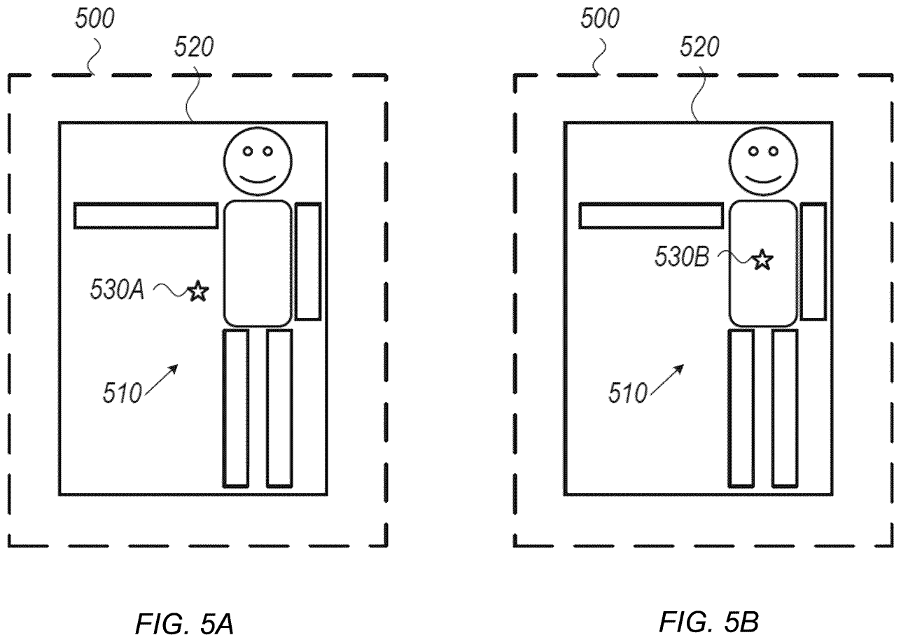

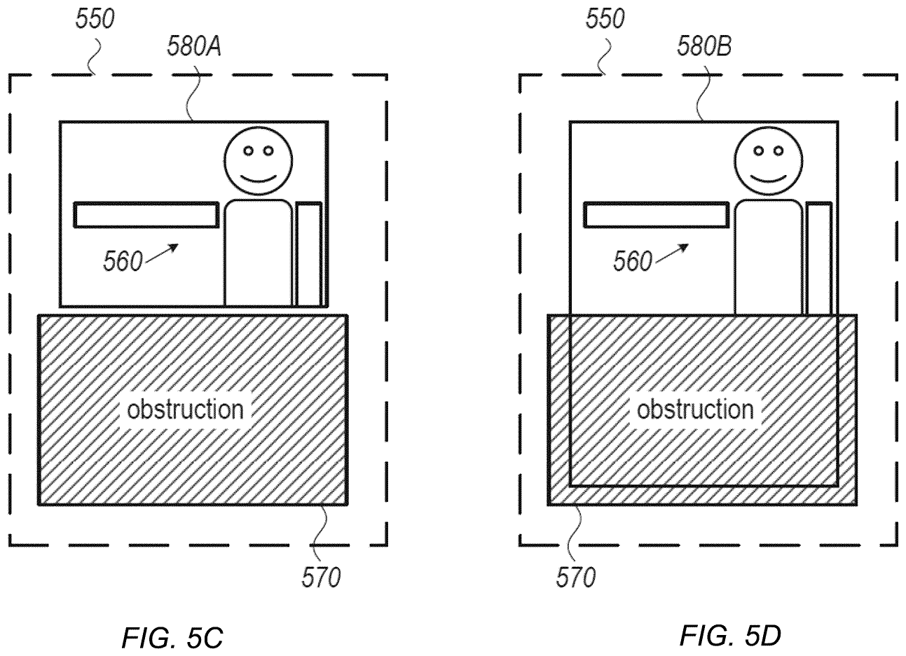

FIGS. 5A and 5B are schematic illustrations exemplifying distinction between geometric centroids and semantic centers for a human subject 510 detected within an image 500, in accordance with one or more embodiments. FIG. 5A illustrates the subject 510 in an extended pose, wherein the subject's right arm is stretched outward. A bounding box 520 encloses the detected region of the subject. A first reference point, labeled 530A, is shown within the image 500. This point 530A represents the geometric center of the bounding box 520. As shown, the geometric center 530A does not coincide with the actual center of the human subject's torso or body mass. Rather, the geometric center is skewed toward the extended limb, resulting in a location outside of the main body region.

FIG. 5B illustrates the same subject 510 in the same pose and within the same bounding box 520. A second reference point, labeled 530B, is shown. This point 530B represents the semantic center of the human subject 510, defined as an anatomically stable location that consistently corresponds to the central region of the torso, irrespective of arm or limb positions. The semantic center 530B lies within the subject's body and serves as a more reliable and consistent reference for further localization tasks such as bounding box regression, pose estimation, and inter-part association.

FIGS. 5C and 5D are schematic illustrations demonstrating an obstruction scenario and corresponding differences in bounding box prediction strategies applied to a partially occluded human subject 580 within an image 550, in accordance with one or more embodiments. As shown in FIG. 5C, the image 550 includes a human subject 560, partially obscured by an obstruction 570 (e.g., a physical object, wall, or furniture) that conceals the lower half of the subject's body. The visible bounding box 580A encloses only the unobstructed, visible portion of the subject 560 above the obstruction. The bounding box shown in FIG. 5C represents a naive or conventional approach to object detection that only localizes the visible area, failing to capture the full spatial footprint of the subject.

FIG. 5D illustrates a more robust and complete bounding box 580B for the same subject 560 under similar occlusion conditions. In this embodiment, the disclosed system employs learned human body priors and predictive modeling to estimate the full extent of the subject's body, including the portion hidden by the obstruction. As a result, the predicted bounding box 580B extends beyond the visible upper portion of the subject to encompass the entire body, including the obstructed region behind the obstruction.

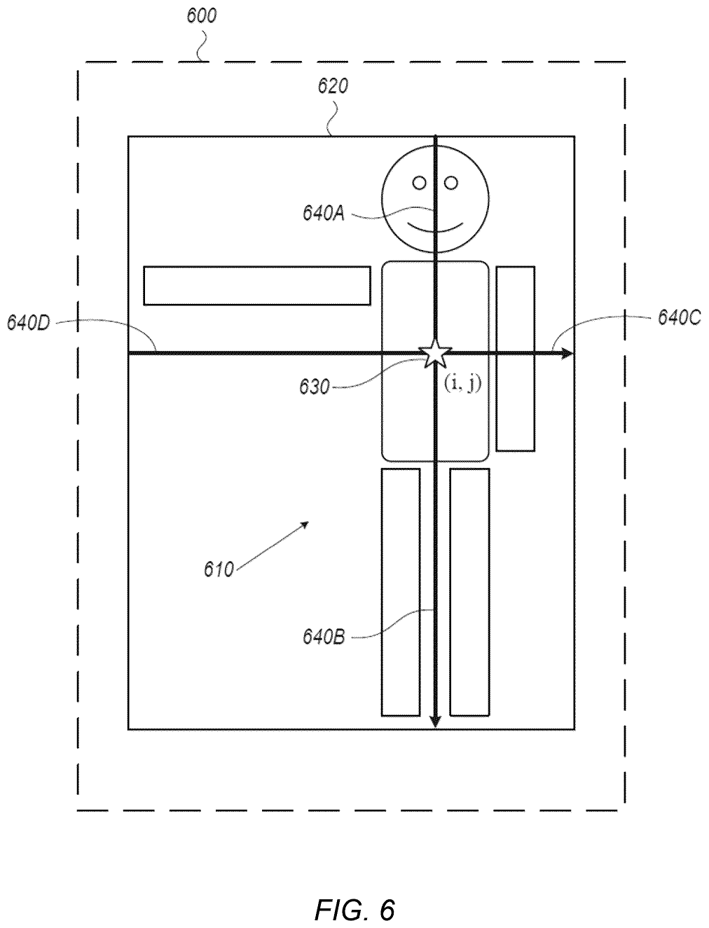

FIG. 6 is a schematic diagram illustrating an exemplary decoding of a body bounding box for a detected human subject in an image based on predicted semantic center coordinates and associated boundary offsets, in accordance with one or more embodiments. As shown in FIG. 6, an image 600 includes a human subject 610 detected within a scene. A bounding box 620 is generated to enclose the body of the subject 610. A semantic center 630 is indicated at coordinates (i, j), which represents an anatomically stable reference point typically corresponding to the geometric center of the torso of subject 610.

The semantic center 630 serves as the anchor point for decoding the full extent of the bounding box 620 using a set of offset values. These offset values may be output by a shape module (e.g., shape module 340 of model 300) and may include a top offset 640A, a bottom offset 640B, a right offset 640C, and a left offset 640D. Each of these offsets defines the distance from the semantic center 630 to a respective boundary of the predicted bounding box 620 along the vertical and horizontal axes.

According to some embodiments, these offsets may be expressed in units relative to the feature map resolution and subsequently adjusted using quantization compensation (e.g., from a quantization compensation module 350) to obtain pixel-accurate coordinates in the original image space. The decoding process transforms the set of offset values and the semantic center coordinates into final bounding box coordinates, such that the bounding box 620 accurately encloses the body of the human subject 610.

This approach, in which bounding box boundaries are defined with respect to semantic center 630, provides enhanced robustness and consistency across different poses, subject scales, and occlusion scenarios, compared to traditional bounding box regression methods that directly predict corner coordinates without reference to a central anatomical anchor. The illustrated configuration enables reliable bounding box prediction even when portions of the subject are occluded or when subjects are in non-standard postures.

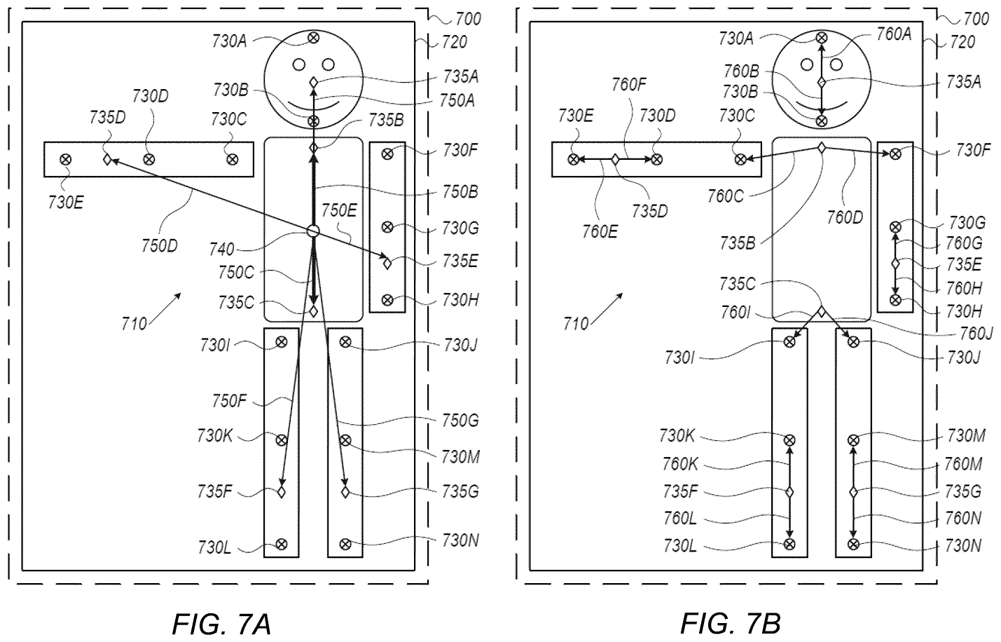

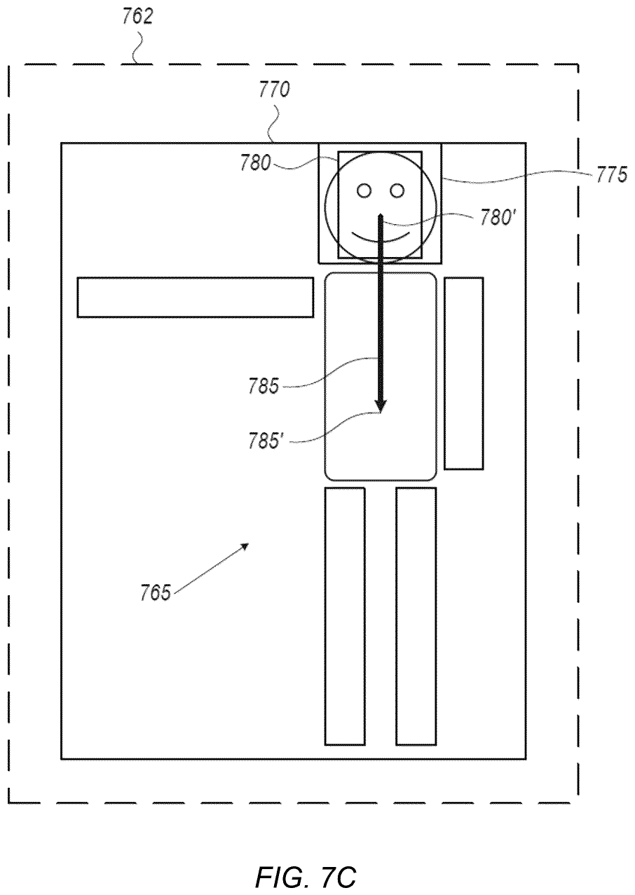

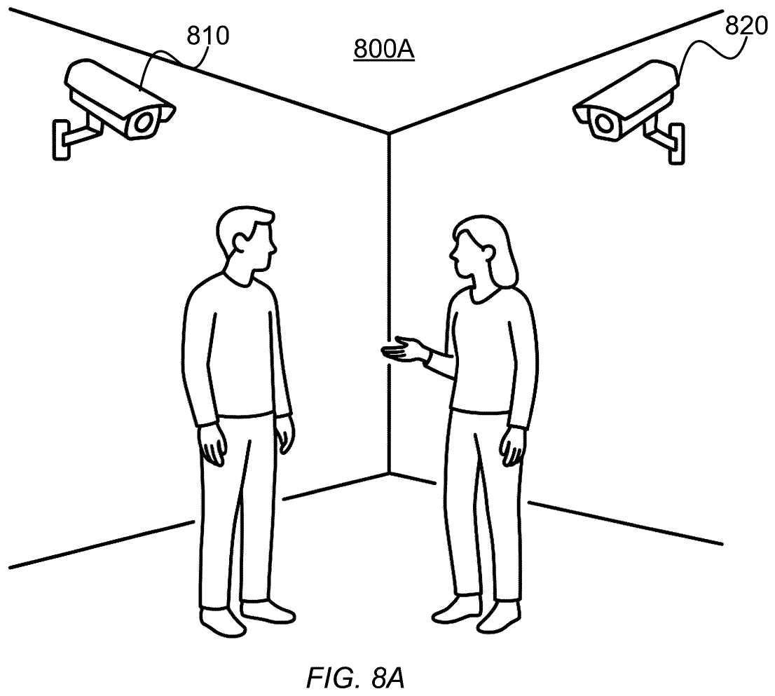

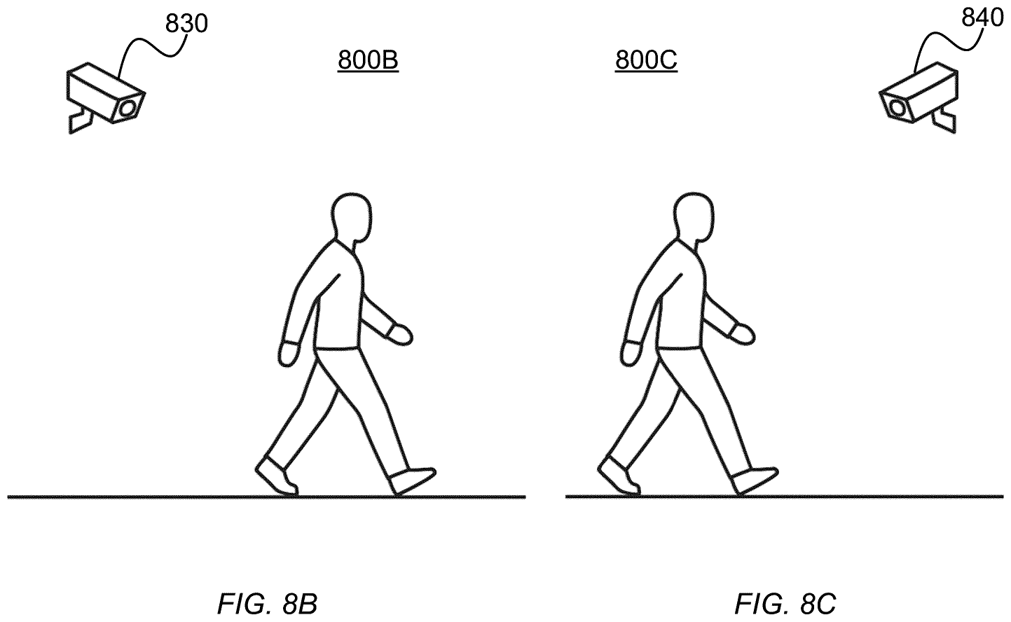

FIGS. 7A and 8B illustrate an exemplary two-stage hierarchical regression process for determining anatomical posture keypoints of a human subject within an image frame, in accordance with one or more embodiments. FIG. 7A depicts a first stage of the regression process for estimating intermediate anatomical landmarks. As shown, an image 700 includes a human subject 710 positioned within a body bounding box 720. The system identifies a semantic center 740 for the subject 710 and predicts a set of intermediate keypoints 750A-750G (represented by small unfilled diamonds), which correspond to anatomically stable intermediate keypoints between major skeletal joints. These intermediate keypoints include, for example, an intermediate head keypoint 735A, intermediate elbow keypoints 735D and 735E, intermediate torso keypoints 735B, 735C, intermediate knee keypoints 735F, 735G.

In this stage, each intermediate keypoint is predicted as a vector offset from the semantic center 740. For example, offset vector 750A illustrates the predicted displacement from semantic center 740 to the intermediate head keypoint 735A; offset vectors 750B, 750C illustrate the predicted displacement from semantic center 740 to the respective intermediate torso keypoints 735B, 735C; the offset vectors 750D, 750E illustrate the predicted displacement from semantic center 740 to the respective intermediate elbow keypoints 735D, 735E; and so on.

FIG. 7B illustrates the second stage of the two-stage regression process, in which final anatomical keypoints (also referred to as posture keypoints) are refined using the intermediate keypoints 735A through 735G as anchor references. In this stage, each of the intermediate keypoints 735A through 735G from FIG. 7A is used as a new center for local refinement. Around each intermediate keypoint, the system predicts one or more final keypoints by applying a localized regression procedure that leverages high-resolution local image features. The refined final keypoints 730A-730N (represented as filled circles) correspond to joints and anatomical extremities such as shoulders, elbows, wrists, hips, knees, and ankles.

For example, from intermediate elbow keypoint 735D, the system predicts and refines final elbow keypoint 730D and wrist keypoint 730E corresponding to the right elbow and wrist, respectively. Similarly, from intermediate torso keypoint 735B, the system generates final shoulder keypoints 730C, 730F, corresponding to the right and left shoulders, respectively.

The outputs of the two-stage process may be combined into a composite pose representation, capturing both coarse and fine skeletal structure. This hierarchical approach significantly enhances anatomical plausibility and robustness to occlusion by first constraining rough keypoint locations using global body context and then refining them with high-resolution local features. The two-stage structure enables accurate human pose estimation in complex visual environments and provides stable, interpretable pose outputs for downstream applications such as behavior recognition, identity tracking, and motion analysis.

FIG. 7C illustrates an example of body part association using a vector for associating multiple detected anatomical components of a single human subject, in accordance with one or more embodiments. FIG. 7C depicts an image 762 containing a human subject 765. The system identifies a head bounding box 780, having a center point 780′, and a body bounding box 770, having a semantic center 785′. The head bounding box 780 may be detected by the detection module or derived from predicted posture keypoints, and may include facial features such as eyes and mouth (as indicated within box 775). The body bounding box 770 encompasses the torso and lower body of the subject 765.

A predicted vector 785 is generated from the center point 780′ of the head bounding box 780 to the semantic center 785′ of the body bounding box 770. The vector 785 represents the expected spatial offset between these two body portions and is learned during training as part of the association module 385. The direction and magnitude of the vector reflect anatomical priors and are used during inference to determine whether the detected head and body belong to the same individual.

The association module 380 may evaluate candidate vectors for multiple subjects within the scene and apply matching criteria, such as spatial proximity, vector consistency, and detection confidence, to associate parts accordingly. In some embodiments, the association vector 785 is compared to actual observed offsets and validated using geometric thresholds and matching algorithms (e.g., the Hungarian algorithm) to assign consistent subject identities.

The use of vectors enables robust association of body parts, even in the presence of partial occlusions or when multiple subjects appear in close proximity. This mechanism allows the system to generate coherent subject-level representations by grouping detected faces, heads, and bodies under a unified identity, which may then be utilized for downstream tasks such as tracking, pose estimation, or behavior recognition.

FIG. 8A illustrates an example monitoring environment 800A equipped with multiple cameras for performing human subject detection and tracking in accordance with one or more embodiments. As shown in FIG. 8A, the environment 800 includes two human subjects positioned within a monitored space. A first camera 810 and a second camera 820 are installed at different physical locations within the environment 800, such as on opposing walls or ceiling corners. The first camera 810 and the second camera 820 are oriented such that their respective fields of view overlap at least partially, thereby enabling the coordinated monitoring of shared spatial regions.

The overlapping fields of view of cameras 810 and 820 facilitate multi-camera subject tracking, allowing the system to observe the same human subject from different angles and perspectives. This configuration enhances detection accuracy and robustness, particularly in cases involving occlusions, perspective distortion, or partial field-of-view coverage by a single camera. In some embodiments, each camera may be associated with individual calibration parameters, and their image outputs may be mapped to a common coordinate system using extrinsic calibration techniques.

The camera configuration illustrated in FIG. 8A supports cross-camera identity association and enables the system to maintain consistent subject identities as individuals move throughout the monitored space. The ability to fuse observations from multiple viewpoints also enables more accurate localization, posture estimation, and behavior recognition, further supporting advanced applications such as security analytics, crowd monitoring, and event detection.

FIGS. 8B and 8C illustrate an example scenario in which a human subject transitions between two spatially separated image capture zones monitored by cameras with non-overlapping fields of view, in accordance with one or more embodiments. As shown in FIG. 8B, a monitoring environment 800B includes a camera 830 configured to observe a subject as the subject traverses through the field of view of the camera 830. The environment 800B corresponds to a first spatial location within a monitored facility. In FIG. 8C, a separate environment 800C includes a second camera 840, positioned to monitor a second, disjoint area of the facility. The field of view of camera 840 does not overlap with that of camera 830.

In the illustrated embodiment, a same human subject is captured independently by both camera 830 and camera 840 at different time instances, as the subject walks from environment 800B to environment 800C. The subject's trajectory includes a transitional region not captured by either camera, thereby precluding direct frame-to-frame visual continuity between the two camera views.

The system may employ cross-camera association techniques, such as re-identification (re-ID) algorithms, trajectory interpolation, semantic fingerprinting, or biometric embeddings, to associate detections of the same subject captured across different non-overlapping camera views. These methods enable the system to maintain consistent subject identifiers despite spatial discontinuities, thereby supporting long-range subject tracking and behavioral analysis across distributed camera networks.

The configuration shown in FIGS. 8B and 8C is representative of common surveillance scenarios in public or commercial facilities, where subjects may move between disconnected camera views. The disclosed system provides robust mechanisms for identity continuity and behavioral reasoning under such conditions, supporting applications such as security surveillance, foot traffic analysis, and zone-based access monitoring.

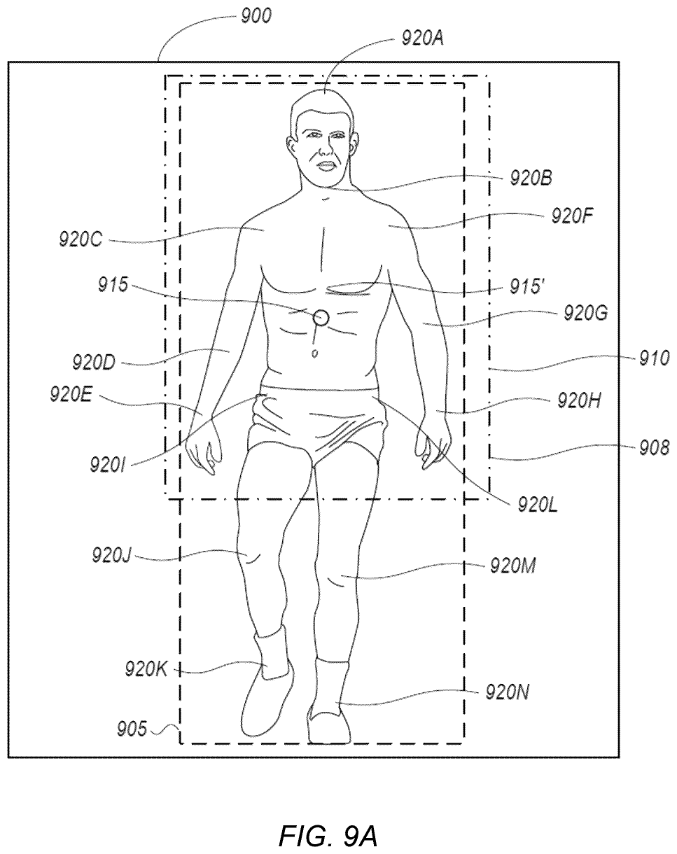

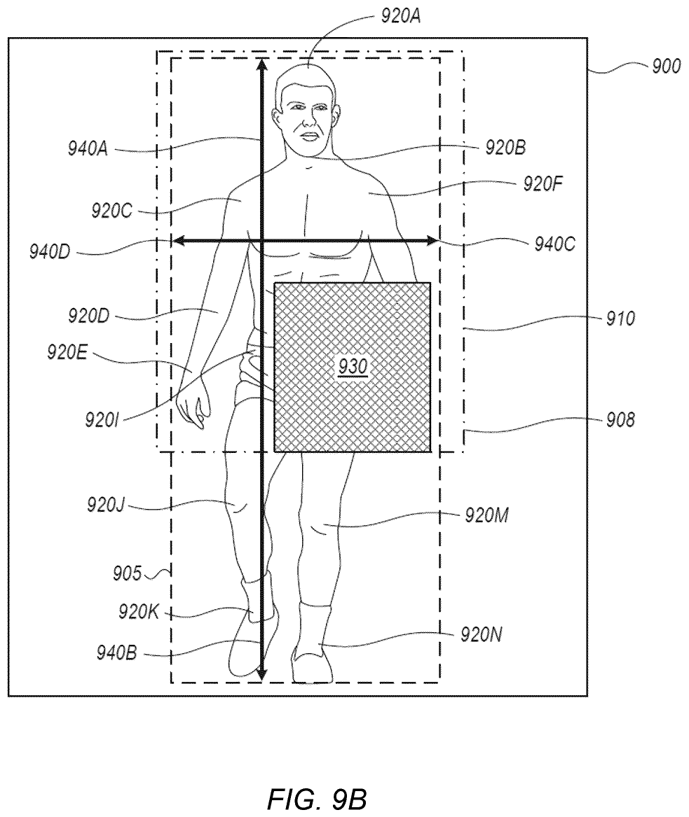

FIG. 9A illustrates an example image frame 900 depicting a human subject 908 and the associated detection outputs generated by a multitask detection module, in accordance with one or more embodiments. The detection results include a full body bounding box 905, a torso bounding box 910, along with a set of detected anatomical keypoints or posture body keypoints, and an inferred semantic center 915′ of the subject's body.

The human subject 908 is shown in a full-body frontal pose within the field of view of the camera. The bounding box 905, illustrated as a dashed rectangular outline, represents the predicted spatial extent of the subject's full body. The bounding box 910, surrounding the subject's torso provide hierarchical localization of smaller anatomical regions within the full-body context.

A plurality of posture body keypoints 920A-920N are shown distributed across the anatomical structure of the subject 908. These body keypoints correspond to standardized skeletal keypoints commonly used for pose estimation tasks and may include, for example: top-of-head 920A, bottom-of-head 920B, shoulders 920C and 920F, elbows 920D and 920G, wrists 920E and 920H, hips 9201 and 920L, knees 920J and 920M, and ankles 920K and 920N. Each body keypoint may be represented by a coordinate pair in image space and may be associated with a confidence score and visibility flag as produced by the landmark and landmark visibility modules, respectively.

A semantic center 915 is illustrated as a reference point located approximately near the mid-torso region of the subject. This semantic center 915 serves as an anatomically stable and consistent origin for expressing relative positions of other detected elements, including bounding boxes and pose keypoints. For example, the location of each of the body keypoints 920A-920N may be represented as an offset from the semantic center 915 in model output tensors.

The body part associations implied by the bounding boxes and skeletal keypoints may be further resolved into structured subject representations using an association module, which links the face, head, and body elements into a coherent subject grouping. These associations support subject-level tracking, re-identification, and behavior analysis across image frames and camera views.

FIG. 9B illustrates an example image frame 950 depicting a human subject 908 who is partially occluded by a foreground object 930, along with associated detection outputs generated by a multitask detection module, in accordance with one or more embodiments. The detection outputs include a predicted full-body bounding box 905, a torso bounding box 908, and a set of anatomical posture keypoints 920A-920N.

In this example, the human subject 908 is partially hidden behind the obstruction 930, which visually blocks the lower half of the body from the camera's perspective. Despite the occlusion, the multitask detection module infers a complete full-body bounding box 905 encompassing both visible and occluded body regions, illustrating the model's ability to reason about full-body extent based on partial observations. The torso bounding box 908 also encloses both the visible and invisible upper portion of the subject and supports hierarchical localization within the full-body context.

A plurality of anatomical posture keypoints 920A-920N are detected and shown across the visible upper body of the subject. These may include, for example: top-of-head 920A, bottom-of-head 920B, shoulders 920C and 920F, elbows 920D and 920G, wrists 920E and 920H, hips 9201 and 920L, knees 920J and 920M, and ankles 920K and 920N. Keypoints corresponding to occluded limbs (such as knees or ankles) may be predicted with lower confidence or may be excluded from the output if not visible. Each keypoint may include a visibility flag and confidence score to indicate reliability under occlusion.

The bounding boxes 905 and 908 are predicted using offset vectors relative to a reference center (not shown) determined during inferencing. The underlying detection model is trained to regress full-body bounding box extents even when only partial visual evidence is available.

The depiction in FIG. 9B showcases the multitask detection system's robustness in real-world conditions, where human subjects are frequently obscured by environmental elements. The use of full-body bounding box inference, torso-level anchoring, and pose keypoint prediction enables consistent subject detection even in the presence of significant occlusion, facilitating downstream tasks such as subject tracking and behavior analysis.

### Teacher-Student Training Architecture

FIG. 10 illustrates a training process 1000 for constructing a unified multitask detection model 1080 using a teacher-student knowledge distillation framework, in accordance with one or more embodiments. The training process 1000 includes a series of dedicated training modules—1071, 1073, 1075, and 1080—each configured to train one of the component models shown in the figure. These modules operate under the broader coordination of the ML training module 260 and facilitate task-specific training, pseudo-label generation, and integration into a unified student model 1082.

A head detection teacher model training module 1071 is configured to train a head detection teacher model 1072 using a curated dataset 1010 of labeled head images. The dataset 1010 includes annotated bounding boxes of human heads across various conditions, such as different camera angles, lighting conditions, occlusions, and subject demographics. The training module 1071 may apply preprocessing techniques including resizing, normalization, random cropping, and head-specific augmentations (e.g., random rotation or contrast adjustment) to prepare the data for training. The teacher model 1072 may implement a deep convolutional object detector such as RetinaNet or YOLOv5, optimized with loss functions like focal loss or generalized IoU. After training, the teacher model 1072 is used to annotate an unlabeled dataset 1040 with high-confidence head bounding boxes to produce a pseudo-labeled dataset 1040′ for downstream use.

A body detection teacher model training module 1073 manages the training of a body detection teacher model 1074 using dataset 1020, which contains labeled body bounding boxes under diverse environmental and pose conditions. Similar to the training model 1072, the training module 1073 may support preprocessing strategies, and be trained using various techniques. Once trained, teacher model 1074 is applied to unlabeled dataset 1050 to generate pseudo-labeled body detection outputs 1050′, including bounding boxes and confidence scores.

A posture keypoints detection teacher model training module 1075 is configured to train a keypoint estimation model 1076 using a dataset 1030 containing skeletal posture annotations. The dataset includes per-frame annotations for human keypoints, such as shoulders, elbows, hips, and knees, along with associated visibility flags. The training module 1075 may apply augmentations that preserve keypoint topology, such as affine warping, keypoint-aware cropping, and synthetic occlusion. The model architecture may include HRNet or a high-resolution PoseNet variant trained using heatmap regression loss, visibility classification loss, and optionally anatomical coherence constraints. The trained teacher model 1076 is then used to annotate an unlabeled dataset 1060 to generate pseudo-labeled posture keypoints 1060′, enabling downstream multitask training.

The unlabeled datasets 1040, 1050, and 1060 may or may not be a same dataset. In some embodiments, the unlabeled datasets 1040, 1050, and 1060 are a same dataset, and the labeled datasets 1040′, 1050′, and 1060′ include a same image labeled with head, body, and posture points.

A multitask detection model training module 1081 receives the pseudo-labeled datasets 1040′, 1050′, and 1060′ and uses them to train a unified multitask detection model 1082. In some embodiments, the multitask detection model training module 1081 may also use labeled datasets 1010, 1020, and 1030 in training of the model 1082.

Notably, the existing labeled datasets 1010, 1020, and 1030 are insufficient, on their own, to directly train the multitask detection model 1080 due to limitations in annotation coverage, task alignment, and data diversity. For example, dataset 1010 may contain a large volume of images with labeled head regions, while dataset 1020 may include a relatively limited number of images with labeled body bounding boxes. As a result, the training data available for each detection task is imbalanced. Further, no single dataset provides a comprehensive set of annotations encompassing head, body, and keypoints within the same image samples.

The student model 1082 is configured with a shared backbone and task-specific heads for detecting heads, bodies, and posture keypoints in a single inference pass. The training module 1081 implements multitask learning strategies, such as balanced or adaptive task weighting, shared feature regularization, and curriculum scheduling, to prevent task interference and promote generalization. In some embodiments, the module applies knowledge distillation losses to enforce similarity between student predictions and teacher-generated pseudo-labels. The final trained model 1080 is stored in the ML models database 296 and may be deployed for real-time inference on edge or cloud-based systems.

In some embodiments, the training process includes validation routines to ensure the integrity and effectiveness of the distillation procedure. These may include comparison of pseudo-label outputs to manual ground truth on held-out validation datasets, statistical consistency analysis, and benchmarking of the multitask model's performance against its teacher models 1072, 1074, 1076.

Additional quality control procedures may include automatic rejection of pseudo-labels below confidence thresholds, validation of skeletal pose coherence based on learned anatomical priors, and ablation studies to evaluate the contribution of each teacher model to overall multitask performance.

The training process 1000 provides a scalable framework for generating accurate multitask detection models without requiring fully annotated datasets for each task. By leveraging teacher models trained on separate labeled datasets and applying them to unlabeled data, the system produces high-quality supervisory signals through pseudo-labeling. The resulting student model achieves unified, efficient inference performance across multiple tasks, supporting robust deployment for human detection, pose estimation, and subject tracking in complex environments.

### Example Method for Human Subject Tracking in Secure Environments

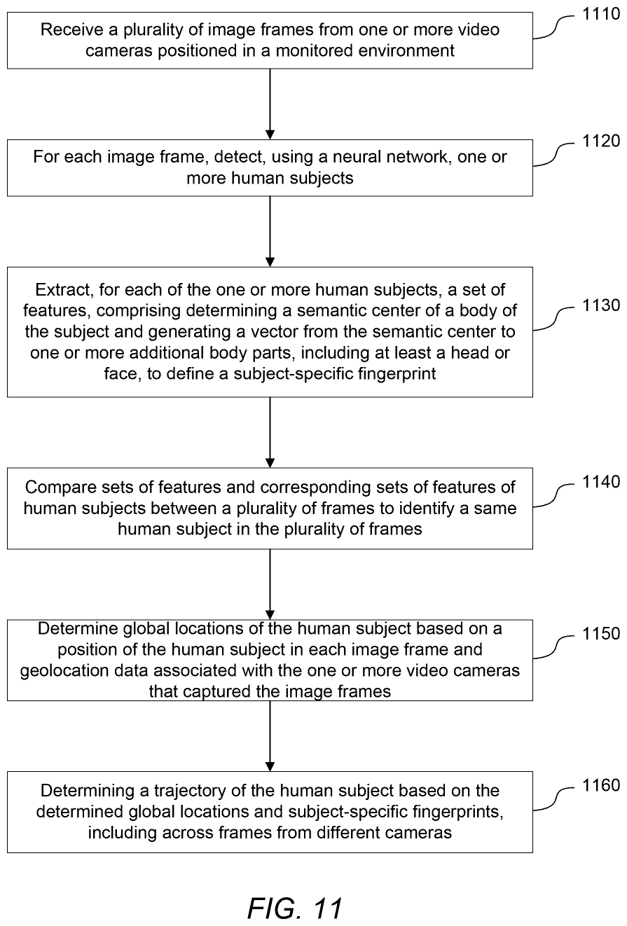

FIG. 11 is a flowchart of a method 1100 for human subject tracking in secure environments, in accordance with one or more embodiments. In various embodiments, the method includes different or additional steps than those described in conjunction with FIG. 11. Further, in some embodiments, the steps of the method may be performed in different orders than the order described in conjunction with FIG. 11. The method described in conjunction with FIG. 11 may be carried out by the subject tracking system 130 in various embodiments, while in other embodiments, the steps of the method are performed by edge device(s) 110, or a combination thereof.

The subject tracking system 130 is configured to receive 1110 a plurality of image frames from one or more video cameras positioned in a monitored environment. In various embodiments, these cameras may include fixed surveillance cameras, pan-tilt-zoom cameras, or mobile cameras operating in indoor or outdoor facilities. The image frames may be received in real time or from recorded video streams and are transmitted to the subject tracking system over a secure communication channel such as an encrypted data tunnel. Upon receipt, the image acquisition module of the system timestamps each frame and associates it with metadata including camera ID, resolution, and geolocation. Frames may also undergo preprocessing operations such as resizing, denoising, or format normalization to ensure compatibility with downstream detection modules. In multi-camera setups, the system includes buffer synchronization logic to maintain temporal alignment between feeds from different cameras. This enables accurate multi-view analysis and enables coherent tracking across distributed observation points.

The subject tracking system 130 is configured to detect 1120, using a neural network, one or more human subjects for each image frame. In some embodiments, the system 130 uses a multitask detection model that receives each image frame and outputs bounding boxes and keypoints for human-related features, such as the head, face, body, and skeletal joints. This neural network includes a shared backbone for feature extraction and a series of specialized heads that detect different parts of the human anatomy. Each detection is computed in a unified forward pass, leveraging shared context across subtasks to improve consistency and efficiency. The model is capable of detecting human subjects even under challenging conditions such as crowding, occlusion, or non-frontal poses. In some embodiments, detection outputs may include confidence scores and spatial alignment data that facilitate downstream tasks such as pose estimation, tracking, and identity association. The multitask approach significantly reduces inference latency while enhancing detection robustness, making it suitable for real-time security applications.

The subject tracking system 130 is configured to extract 1130, for each of the one or more human subjects, a set of features, comprising determining a semantic center of a body of the subject and generating a vector from the semantic center to one or more additional body parts, including at least a head or face, to define a subject-specific fingerprint. The semantic center, such as the mid-torso, is a stable anatomical reference point used to anchor relative measurements. The system calculates vectors from the semantic center to other detected parts, including the head and face, which capture consistent geometric relationships independent of pose or partial occlusion. These vectors, along with appearance-based embeddings derived from facial, head, and body regions, form a composite subject-specific fingerprint. This fingerprint serves as a high-dimensional signature for each subject, enabling the system to track identity across frames and cameras with improved resilience to visual variance, lighting, and orientation.

The subject tracking system 130 is configured to compare 1140 sets of features and corresponding sets of features of human subjects between a plurality of frames to identify a same human subject in the plurality of frames. This comparison is part of a multi-stage tracking process in which each newly detected subject is matched against existing tracks based on appearance similarity, semantic geometry, and spatial continuity. The system uses deep feature embeddings, derived from detected head, face, and body regions, to evaluate appearance similarity using distance metrics such as cosine similarity or Euclidean distance. Simultaneously, it considers the relative displacement between the semantic center and other body parts (via vectors) to ensure consistent body configuration. To support robust association even under occlusion or camera transition, the system incorporates predictive motion modeling (e.g., via Kalman filters) and temporal constraints. Together, these mechanisms allow the system to maintain persistent identity for each subject across time and across visual disruptions.

The subject tracking system 130 is configured to determine 1150 global locations of the human subject based on a position of the human subject in each image frame and geolocation data associated with the one or more video cameras that captured the image frames. In some embodiments, the system 130 may translate pixel-space coordinates into global spatial coordinates using extrinsic and intrinsic parameters of each camera. These include mounting height, lens distortion coefficients, rotation matrices, and translation vectors, which allow the system to map detections to a shared coordinate system representing real-world space. This global mapping is advantageous in multi-camera environments, enabling spatial correlation of detections across sensors with differing viewpoints or non-overlapping fields of view. The system 130 may also divide the environment into semantic zones—such as restricted areas or entryways—and assign zone IDs to each global coordinate. This transformation facilitates real-time behavior monitoring, trajectory computation, and identity handoff across disparate visual perspectives.

The subject tracking system 130 is configured to determine 1160 a trajectory of the human subject based on the determined global locations and subject-specific fingerprints, including across frames from different cameras. Trajectories are constructed by associating detections of the same subject over time, using both spatial and appearance-based cues. The system continuously updates each subject's path by integrating global coordinates from camera calibration, predictive motion models (e.g., velocity estimates via Kalman filters), and fingerprint similarity scores. In multi-camera environments, trajectory stitching includes inter-camera identity handoff using shared world coordinates and fingerprint embeddings, allowing the system to track subjects across different camera views-even in the absence of direct visual continuity. The resulting trajectories are stored as time-series data in a trajectory and event database and can be analyzed for activity recognition, zone entry and exit events, or abnormal behavior detection. This comprehensive tracking enables persistent monitoring of individuals within large or complex environments.

### Example Computing System

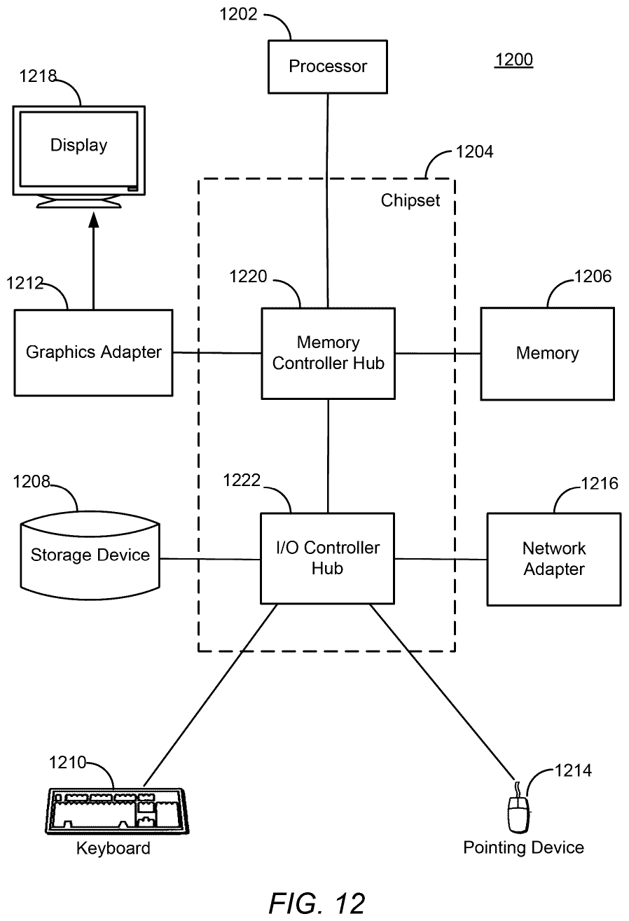

FIG. 12 is a block diagram of an example computer 1200 suitable for use in the networked computing environment 100 of FIG. 1. The computer 1200 is a computer system and is configured to perform specific functions as described herein. For example, the specific functions corresponding to the subject tracking system 130 may be configured through the computer 1200.

The example computer 1200 includes a processor system having one or more processors 1202 coupled to a chipset 1204. The chipset 1204 includes a memory controller hub 1220 and an input/output (I/O) controller hub 1222. A memory system having one or more memories 1206 and a graphics adapter 1212 are coupled to the memory controller hub 1220, and a display 1218 is coupled to the graphics adapter 1212. A storage device 1208, keyboard 1210, pointing device 1214, and network adapter 1216 are coupled to the I/O controller hub 1222. Other embodiments of the computer 1200 have different architectures.

In the embodiment shown in FIG. 12, the storage device 1208 is a non-transitory computer-readable storage medium such as a hard drive, compact disk read-only memory (CD-ROM), DVD, or a solid-state memory device. The memory 1206 holds instructions and data used by the processor 1202. The pointing device 1214 is a mouse, track ball, touchscreen, or other types of a pointing device and may be used in combination with the keyboard 1210 (which may be an on-screen keyboard) to input data into the computer 1200. The graphics adapter 1212 displays images and other information on the display 1218. The network adapter 1216 couples the computer 1200 to one or more computer networks, such as network 150.

The types of computers used by the entities and the subject tracking system 130 of FIGS. 1 through 12 can vary depending upon the embodiment and the processing power required by the enterprise. For example, the subject tracking system 130 might include multiple blade servers working together to provide the functionality described. Furthermore, the computers can lack some of the components described above, such as keyboards 1210, graphics adapters 1212, and displays 1218.

### Additional Considerations

The disclosed embodiments enable robust, real-time tracking of human subjects across multiple video frames and camera views using a unified multitask detection and identity association framework. Unlike traditional surveillance systems that rely on separate, task-specific models for detecting individual body parts, the disclosed system employs a single neural network that concurrently detects multiple human features-such as the face, head, body, and anatomical keypoints-using shared feature representations and directional vectors anchored to a semantic body center. This architecture improves detection consistency, reduces computational overhead, and enhances identity continuity in crowded or occluded scenes. Furthermore, by mapping image-space detections to global spatial coordinates using camera calibration data, the system enables accurate cross-camera subject tracking, even in environments with non-overlapping fields of view. The integration of semantic fingerprints and motion modeling allows for persistent identity tracking despite transient visibility loss, resulting in a system that is both more accurate and more resilient than conventional approaches.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for human subject tracking in secure environments, comprising:
receiving a plurality of image frames from one or more video cameras positioned in a monitored environment;
for each image frame, detecting, using a neural network, one or more human subjects;
extracting, for each of the one or more human subjects, a set of features, the extracting comprising:
determining a semantic center of a body of the subject, and
generating a set of vectors from the semantic center to one or more additional body parts to define a subject-specific fingerprint;
comparing sets of features and corresponding sets of features of human subjects between a plurality of frames to identify a same human subject in the plurality of frames;
determining global locations of the human subject based on a position of the human subject in each image frame and geolocation data associated with the one or more video cameras that captured the image frames; and
determining a trajectory of the human subject based on the determined global locations and subject-specific fingerprints, including across frames from different cameras.

2. The method of claim 1, wherein the comparing of features across cameras includes:
detecting a first subject from a first camera;
extracting a first subject-specific fingerprint for the first subject;
mapping the first subject-specific fingerprint to a first global coordinate derived from camera calibration data of the first camera;
detecting a second subject from a second camera;
extracting a second subject-specific fingerprint for the second subject;
mapping the second subject-specific fingerprint to a second global coordinate derived from camera calibration data of the second camera;
determining whether the mapped first subject-specific fingerprint and first global coordinate and the mapped second subject-specific fingerprint and second global coordinate match within a predetermined threshold; and
in response to a match, determining that the two detection from the first camera and second camera correspond to a same subject.

3. The method of claim 1, wherein the vector comprises a directional offset between the semantic center and the center of a head or face bounding box, the offset being used to verify anatomical consistency.

4. The method of claim 3, further comprising: determining whether a detected head or face bounding box and the semantic center belong to a same human subject based on whether the offset is within a predetermined angular or magnitude threshold.

5. The method of claim 1, wherein determining the trajectory includes applying a Kalman filter to predict subject movement during temporary detection gaps.

6. The method of claim 1, wherein determining global locations includes transforming pixel coordinates into world coordinates using extrinsic camera calibration parameters.

7. The method of claim 2, further comprising identifying an exit zone from a first camera and an entry zone in a second camera to aid in determining whether two detections correspond to the same human subject.

8. The method of claim 2, wherein the determination of a same subject includes evaluating whether a time between the two detections falls within a predefined transition window.

9. The method of claim 1, further comprising aggregating subject detections and alerts from multiple cameras into a unified display interface showing status indicators for a plurality of monitoring sites.

10. The method of claim 9, wherein the unified display interface includes a threat level indicator for each site based on frequency, severity, and confidence of detected events.

11. A non-transitory computer readable storage medium for storing instructions that when executed by one or more processors cause the one or more processors to perform steps comprising:
receiving a plurality of image frames from one or more video cameras positioned in a monitored environment;
for each image frame, detecting, using a neural network, one or more human subjects;
extracting, for each of the one or more human subjects, a set of features, the extracting comprising:
determining a semantic center of a body of the subject, and
generating a set of vectors from the semantic center to one or more additional body parts to define a subject-specific fingerprint;
comparing sets of features and corresponding sets of features of human subjects between a plurality of frames to identify a same human subject in the plurality of frames;
determining global locations of the human subject based on a position of the human subject in each image frame and geolocation data associated with the one or more video cameras that captured the image frames; and
determining a trajectory of the human subject based on the determined global locations and subject-specific fingerprints, including across frames from different cameras.

12. The non-transitory computer readable storage medium of claim 11, wherein the comparing of features across cameras includes:
detecting a first subject from a first camera;
extracting a first subject-specific fingerprint for the first subject;
mapping the first subject-specific fingerprint to a first global coordinate derived from camera calibration data of the first camera;
detecting a second subject from a second camera;
extracting a second subject-specific fingerprint for the second subject;
mapping the second subject-specific fingerprint to a second global coordinate derived from camera calibration data of the second camera;
determining whether the mapped first subject-specific fingerprint and first global coordinate and the mapped second subject-specific fingerprint and second global coordinate match within a predetermined threshold; and
in response to a match, determining that the two detection from the first camera and second camera correspond to a same subject.

13. The non-transitory computer readable storage medium of claim 11, wherein the vector comprises a directional offset between the semantic center and the center of a head or face bounding box, the offset being used to verify anatomical consistency.

14. The non-transitory computer readable storage medium of claim 13, further comprising: determining whether a detected head or face bounding box and the semantic center belong to a same human subject based on whether the offset is within a predetermined angular or magnitude threshold.

15. The non-transitory computer readable storage medium of claim 11, wherein determining the trajectory includes applying a Kalman filter to predict subject movement during temporary detection gaps.

16. The non-transitory computer readable storage medium of claim 11, wherein determining global locations includes transforming pixel coordinates into world coordinates using extrinsic camera calibration parameters.

17. The non-transitory computer readable storage medium of claim 12, the steps further comprising identifying an exit zone from a first camera and an entry zone in a second camera to aid in determining whether two detections correspond to the same human subject.

18. The non-transitory computer readable storage medium of claim 12, wherein the determination of a same subject includes evaluating whether a time between the two detections falls within a predefined transition window.

19. The non-transitory computer readable storage medium of claim 11, the steps further comprising aggregating subject detections and alerts from multiple cameras into a unified display interface showing status indicators for a plurality of monitoring sites.

20. A computing system, comprising:
one or more processors; and
a non-transitory computer readable storage medium for storing instructions that when executed by one or more processors cause the one or more processors to perform steps comprising:
receiving a plurality of image frames from one or more video cameras positioned in a monitored environment;
for each image frame, detecting, using a neural network, one or more human subjects;
extracting, for each of the one or more human subjects, a set of features, the extracting comprising:
determining a semantic center of a body of the subject, and
generating a set of vectors from the semantic center to one or more additional body parts to define a subject-specific fingerprint;
comparing sets of features and corresponding sets of features of human subjects between a plurality of frames to identify a same human subject in the plurality of frames;
determining global locations of the human subject based on a position of the human subject in each image frame and geolocation data associated with the one or more video cameras that captured the image frames; and
determining a trajectory of the human subject based on the determined global locations and subject-specific fingerprints, including across frames from different cameras.
